(19) United States
(12) Patent Application Publication
(10) Pub. No.: US 2026/0080519 A1
(43) Pub. Date: Mar. 19, 2026

(54) COMMUNICATION AND SENSING OF PHYSICAL LEVEL IMAGE COMPRESSION

(71) Applicant: QUALCOMM Incorporated, San Diego, CA (US)

(72) Inventors: David YUNUSOV, Holon (IL); Shay LANDIS, Hod Hasharon (IL)

(21) Appl. No.: 18/889,943

(22) Filed: Sep. 19, 2024

(51) Int. Cl. G06T 5/77; G01S 13/04; G06T 7/10; G06T 7/70; G06T 9/00

(52) U.S. Cl. CPC G06T 5/77; G01S 13/04; G06T 7/10; G06T 7/70; G06T 9/00

(57) ABSTRACT

Methods, systems, and devices for wireless communications are described. An extended reality (XR) user equipment (UE) may offload image processing to another UE or network entity (e.g., a receiving device). Some XR devices may implement inpainting techniques via which a portion of the image data is removed and then reconstructed using, for example, a generative adversarial network (GAN) employed by the receiving device in order to reduce the amount of image data transmitted from the XR device to the receiving device. Radio frequency (RF) sensing of an environment may be used to supplement inpainting compression as RF sensing may be used to detect blockages and/or objects behind blockages. RF sensing may be used to determine which portions of an image to remove and/or to reconstruct an image using an inpainting scheme.

### FIELD OF TECHNOLOGY

The following relates to wireless communications, including communication and sensing of physical level image compression.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting, to a wireless communication device, an indication of an intended portion of image data to remove from an image in accordance with an inpainting scheme, receiving, from the wireless communication device, an indication of at least a subset of image data of the intended portion of the image data to remove from the image in accordance with the inpainting scheme and a radio frequency (RF) sensing of an environment associated with the image, removing the subset of image data to obtain a masked image, the masked image having less data than the image, compressing, according to a compression scheme, the masked image to obtain a compressed image, the compressed image having less data than the masked image based on the compression, and transmitting, to the wireless communication device, the compressed image.

An apparatus for wireless communication at a UE is described. The apparatus may include: one or more processors; one or more memories coupled with the one or more processors; and one or more processor-readable instructions stored in the one or more memories and executable by the one or more processors individually or collectively to cause the apparatus to transmit, to a wireless communication device, an indication of an intended portion of image data to remove from an image in accordance with an inpainting scheme, receive, from the wireless communication device, an indication of at least a subset of image data of the intended portion of the image data to remove from the image in accordance with the inpainting scheme and a RF sensing of an environment associated with the image, remove the subset of image data to obtain a masked image, the masked image having less data than the image, compress, according to a compression scheme, the masked image to obtain a compressed image, the compressed image having less data than the masked image based on the compression, and transmit, to the wireless communication device, the compressed image.

A UE for wireless communication is described. The UE may include means for transmitting, to a wireless communication device, an indication of an intended portion of image data to remove from an image in accordance with an inpainting scheme, means for receiving, from the wireless communication device, an indication of at least a subset of image data of the intended portion of the image data to remove from the image in accordance with the inpainting scheme and a RF sensing of an environment associated with the image, means for removing the subset of image data to obtain a masked image, the masked image having less data than the image, means for compressing, according to a compression scheme, the masked image to obtain a compressed image, the compressed image having less data than the masked image based on the compression, and means for transmitting, to the wireless communication device, the compressed image.

A non-transitory computer-readable medium storing code for wireless communication is described. The code may include instructions executable by one or more processors to transmit, to a wireless communication device, an indication of an intended portion of image data to remove from an image in accordance with an inpainting scheme, receive, from the wireless communication device, an indication of at least a subset of image data of the intended portion of the image data to remove from the image in accordance with the inpainting scheme and a RF sensing of an environment associated with the image, remove the subset of image data to obtain a masked image, the masked image having less data than the image, compress, according to a compression scheme, the masked image to obtain a compressed image, the compressed image having less data than the masked image based on the compression, and transmit, to the wireless communication device, the compressed image.

In some examples of the method, apparatuses, UEs, and non-transitory computer-readable medium described herein, sensing, via one or more RF signals, one or more objects in the environment, where the intended portion of the image data may be selected based on the sensing the one or more objects.

Some examples of the method, apparatuses, UEs, and non-transitory computer-readable medium described herein may further include operations, features, means, or instructions for capturing, via an image sensor of the UE, the image, where one or more second objects block the one or more objects with respect to the image sensor.

Some examples of the method, apparatuses, UEs, and non-transitory computer-readable medium described herein may further include operations, features, means, or instructions for capturing, via the image sensor, one or more second images prior to capture of the image, where the inpainting scheme may be based on the one or more second images, and where the one or more second objects may be absent from the one or more second images.

Some examples of the method, apparatuses, UEs, and non-transitory computer-readable medium described herein may further include operations, features, means, or instructions for determining, based on the sensing, a change in position of the one or more objects at a time of the image with respect to the one or more second images, where the intended portion of the image data may be selected based on the change in position.

In some examples of the method, apparatuses, UEs, and non-transitory computer-readable medium described herein, sensing, via the one or more RF signals may include operations, features, means, or instructions for transmitting the one or more RF signals and receiving one or more reflected RF signals corresponding to the one or more RF signals that reflected off the one or more objects.

In some examples of the method, apparatuses, UEs, and non-transitory computer-readable medium described herein, sensing, via the one or more RF signals may include operations, features, means, or instructions for receiving the one or more RF signals from the wireless communication device, where the one or more RF signals reflected off the one or more objects.

In some examples of the method, apparatuses, UEs, and non-transitory computer-readable medium described herein, the one or more RF signals include frequency range two RF signals, sub-terahertz RF signals, or a combination thereof.

Some examples of the method, apparatuses, UEs, and non-transitory computer-readable medium described herein may further include operations, features, means, or instructions for communicating, with the wireless communication device, one or more RF sensing parameters associated with the RF sensing of the environment.

In some examples of the method, apparatuses, UEs, and non-transitory computer-readable medium described herein, the one or more RF sensing parameters include one or more of an angle of arrival, an angle of departure, a received signal strength indicator, a time difference of arrival, or a combination thereof.

Some examples of the method, apparatuses, UEs, and non-transitory computer-readable medium described herein may further include operations, features, means, or instructions for communicating, with the wireless communication device, capability signaling indicating a capability of the wireless communication device to indicate subsets of intended portions of image data to remove based on RF sensing of the environment, where transmitting the indication of the intended portion of the image data may be based on the capability signaling.

In some examples of the method, apparatuses, UEs, and non-transitory computer-readable medium described herein, removing the subset of image data may include operations, features, means, or instructions for removing the subset of image data from the image or from a field-of-view region of the image, the field-of-view region being based on one or more sensors associated with the UE.

In some examples of the method, apparatuses, UEs, and non-transitory computer-readable medium described herein, the subset of image data may be removed in accordance with the inpainting scheme based on the RF sensing of the environment.

In some examples of the method, apparatuses, UEs, and non-transitory computer-readable medium described herein, and the method, apparatuses, and non-transitory computer-readable medium may include further operations, features, means, or instructions for removing a masked portion of the image, removing a set of masked portions from each image in a corresponding set of images, removing a frame image from a video, or a combination thereof.

Some examples of the method, apparatuses, UEs, and non-transitory computer-readable medium described herein may further include operations, features, means, or instructions for communicating with the wireless communication device to train the inpainting scheme to recover the image from the compressed image, where the inpainting scheme may be based on the training.

In some examples of the method, apparatuses, UEs, and non-transitory computer-readable medium described herein, transmitting the indication of the intended portion of the image data may include operations, features, means, or instructions for transmitting the indication via a RF band, where the RF sensing may be associated with the RF band.

In some examples of the method, apparatuses, UEs, and non-transitory computer-readable medium described herein, the masked image includes a remainder of the intended portion of image data other than the subset of image data.

A method for wireless communication by a wireless communication device is described. The method may include receiving, from a UE, an indication of an intended portion of image data to remove from an image in accordance with an inpainting scheme, sensing, via one or more RF signals, one or more objects in an environment associated with the image, transmitting, to the UE, an indication of at least a subset of image data of the intended portion of the image data to remove from the image in accordance with the inpainting scheme and based on the one or more objects in the environment sensed via the one or more RF signals, receiving, from the UE, a compressed image, decompressing, according to a compression scheme, the compressed image to obtain a masked image, and reconstructing, according to the inpainting scheme and the indication of the subset of image data of the intended portion of the image data to remove, the image from the masked image.

An apparatus for wireless communication at a wireless communication device is described. The apparatus may include: one or more processors; one or more memories coupled with the one or more processors; and one or more processor-readable instructions stored in the one or more memories and executable by the one or more processors individually or collectively to cause the apparatus to receive, from a UE, an indication of an intended portion of image data to remove from an image in accordance with an inpainting scheme, sensing, via one or more RF signals, one or more objects in an environment associate with the image, transmit, to the UE, an indication of at least a subset of image data of the intended portion of the image data to remove from the image in accordance with the inpainting scheme and based on the one or more objects in the environment sensed via the one or more RF signals, receive, from the UE, a compressed image, decompress, according to a compression scheme, the compressed image to obtain a masked image, and reconstruct, according to the inpainting scheme and the indication of the subset of image data of the intended portion of the image data to remove, the image from the masked image.

A wireless communication device for wireless communication is described. The wireless communication device may include means for receiving, from a UE, an indication of an intended portion of image data to remove from an image in accordance with an inpainting scheme, means for sensing, via one or more RF signals, one or more objects in an environment associated with the image, means for transmitting, to the UE, an indication of at least a subset of image data of the intended portion of the image data to remove from the image in accordance with the inpainting scheme and based on the one or more objects in the environment sensed via the one or more RF signals, means for receiving, from the UE, a compressed image, means for decompressing, according to a compression scheme, the compressed image to obtain a masked image, and means for reconstructing, according to the inpainting scheme and the indication of the subset of image data of the intended portion of the image data to remove, the image from the masked image.

A non-transitory computer-readable medium storing code for wireless communication is described. The code may include instructions executable by one or more processors to receive, from a UE, an indication of an intended portion of image data to remove from an image in accordance with an inpainting scheme, sensing, via one or more RF signals, one or more objects in an environment associate with the image, transmit, to the UE, an indication of at least a subset of image data of the intended portion of the image data to remove from the image in accordance with the inpainting scheme and based on the one or more objects in the environment sensed via the one or more RF signals, receive, from the UE, a compressed image, decompress, according to a compression scheme, the compressed image to obtain a masked image, and reconstruct, according to the inpainting scheme and the indication of the subset of image data of the intended portion of the image data to remove, the image from the masked image.

Some examples of the method, apparatuses, wireless communication devices, and non-transitory computer-readable medium described herein may further include operations, features, means, or instructions for determining, based on the sensing, that one or more second objects block the one or more objects with respect to a field of view of the UE, where the subset of image data may be based on determining that the one or more second objects block the one or more objects with respect to the field of view of the UE.

Some examples of the method, apparatuses, wireless communication devices, and non-transitory computer-readable medium described herein may further include operations, features, means, or instructions for receiving, from the UE, one or more second images prior to receiving the indication of the intended portion of the image data to remove, where the inpainting scheme may be based on the one or more second images, and where the one or more second objects may be absent from the one or more second images.

Some examples of the method, apparatuses, wireless communication devices, and non-transitory computer-readable medium described herein may further include operations, features, means, or instructions for determining, based on the sensing, a change in position of the one or more objects at a time subsequent to the one or more second images, where the subset of image data may be based on the change in position.

In some examples of the method, apparatuses, wireless communication devices, and non-transitory computer-readable medium described herein, sensing, via the one or more RF signals may include operations, features, means, or instructions for transmitting the one or more RF signals and receiving one or more reflected RF signals corresponding to the one or more RF signals that reflected off the one or more objects.

In some examples of the method, apparatuses, wireless communication devices, and non-transitory computer-readable medium described herein, sensing, via the one or more RF signals may include operations, features, means, or instructions for receiving the one or more RF signals from the UE, where the one or more RF signals reflected off the one or more objects.

In some examples of the method, apparatuses, wireless communication devices, and non-transitory computer-readable medium described herein, the one or more RF signals include frequency range two RF signals, sub-terahertz RF signals, or a combination thereof.

Some examples of the method, apparatuses, wireless communication devices, and non-transitory computer-readable medium described herein may further include operations, features, means, or instructions for communicating, with the UE, one or more RF sensing parameters associated with RF sensing of the environment, where the sensing may be based on the one or more RF sensing parameters.

In some examples of the method, apparatuses, wireless communication devices, and non-transitory computer-readable medium described herein, the one or more RF sensing parameters include one or more of an angle of arrival, an angle of departure, a received signal strength indicator, a time difference of arrival, or a combination thereof.

Some examples of the method, apparatuses, wireless communication devices, and non-transitory computer-readable medium described herein may further include operations, features, means, or instructions for communicating, with the UE, capability signaling indicating a capability of the wireless communication device to indicate subsets of intended portions of image data to remove based on RF sensing of the environment, where reception the indication of the intended portion of the image data may be based on the capability signaling.

Some examples of the method, apparatuses, wireless communication devices, and non-transitory computer-readable medium described herein may further include operations, features, means, or instructions for communicating with the UE to train the inpainting scheme to recover the image from the compressed image, where the inpainting scheme may be based on the training.

Some examples of the method, apparatuses, wireless communication devices, and non-transitory computer-readable medium described herein may further include operations, features, means, or instructions for receiving the indication via a RF band, where the one or more RF signals may be associated with the RF band.

In some examples of the method, apparatuses, wireless communication devices, and non-transitory computer-readable medium described herein, the image may be reconstructed from the masked image according to the inpainting scheme based on the sensing.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports communication and sensing of physical level image compression in accordance with one or more aspects of the present disclosure.

FIG. 2 shows an example of a wireless communications system that supports communication and sensing of physical level image compression in accordance with one or more aspects of the present disclosure.

FIG. 3 shows an example of a wireless communications system that supports communication and sensing of physical level image compression in accordance with one or more aspects of the present disclosure.

FIG. 4 shows an example of a generative adversarial network (GAN) that supports communication and sensing of physical level image compression in accordance with one or more aspects of the present disclosure.

FIG. 5 shows an example of an image reconstruction model that supports communication and sensing of physical level image compression in accordance with one or more aspects of the present disclosure.

FIG. 6 shows an example of a wireless communications system that supports communication and sensing of physical level image compression in accordance with one or more aspects of the present disclosure.

FIG. 7 shows an example of a process flow that supports communication and sensing of physical level image compression in accordance with one or more aspects of the present disclosure.

FIGS. 8 and 9 show block diagrams of devices that support communication and sensing of physical level image compression in accordance with one or more aspects of the present disclosure.

FIG. 10 shows a block diagram of a communications manager that supports communication and sensing of physical level image compression in accordance with one or more aspects of the present disclosure.

FIG. 11 shows a diagram of a system including a device that supports communication and sensing of physical level image compression in accordance with one or more aspects of the present disclosure.

FIGS. 12 and 13 show block diagrams of devices that support communication and sensing of physical level image compression in accordance with one or more aspects of the present disclosure.

FIG. 14 shows a block diagram of a communications manager that supports communication and sensing of physical level image compression in accordance with one or more aspects of the present disclosure.

FIG. 15 shows a diagram of a system including a device that supports communication and sensing of physical level image compression in accordance with one or more aspects of the present disclosure.

FIGS. 16 through 19 show flowcharts illustrating methods that support communication and sensing of physical level image compression in accordance with one or more aspects of the present disclosure.

### DETAILED DESCRIPTION

Wireless communication networks may include extended-reality (XR) devices worn or otherwise carried by users. The XR devices may include various cameras and sensors designed to dynamically augment the environment of the user with additional information. Processing and communication loads for such XR devices may result in some functions being offloaded from the XR device to another device, such as to a user equipment (UE) (for example, a UE of the user of the XR device), or to the network (e.g., a network entity). One example of such offloading includes image processing where an image (e.g., a single image or images of a video) taken by the XR device is relayed to the UE (or network entity) for processing (e.g., for pattern/object recognition to determine useful environmental augmentation information). However, the amount of data used to communicate the image (or video) from the XR device to the UE (or network entity) may be extensive, resulting in image compression techniques being applied to the image before transmission. Some XR devices may implement inpainting techniques via which a portion of the image data is removed prior to transmission and then reconstructed at the receiving device using, for example, a generative adversarial network (GAN) employed by the receiving device. For example, inpainting may be a method of image/video editing, such as text-removal or object removal and object re-generation that implements machine learning algorithms, such as a GAN. In inpainting schemes. In inpainting schemes, the image/video may be recreated with the previously removed objects. An example inpainting scheme may be described in “RF-Inpainter: Multimodal Image Inpainting Based on Vision and Radio Signals” by C. Chen, T. Nishio, M. Bennis and J. Park in IEEE Access (Volume: 10), pages 110689-110700, published 14 Oct. 2022, which is incorporated by reference in its entirety. In inpainting schemes, inpainting of future frames may be performed based on provision of some previously seen frames as input to the device or algorithm in combination with estimating movement of pixels. Thus, sudden object insertion in a masked area may not properly be reconstructed.

In some examples, radio frequency (RF) sensing of an environment may be used to supplement inpainting compression as RF sensing may be used to detect blockages and/or objects behind blockages. XR devices and the receiving device may have RF communications capabilities (e.g., 5G NR, Bluetooth, Wi-Fi). RF signals associated with such RF communications capabilities may be used for environment sensing. For example, an XR device (e.g., an XR UE) may transmit an indication of a portion of an image the XR device intends to remove as part of the inpainting scheme. The receiving wireless communication device may sense the environment of the image using RF signals to determine whether the XR device is to remove the indicated portion of the image and/or which sub-portions of the portion for the XR device to remove (e.g., based on blockages in the portion). The receiving device may transmit an indication of the suggested sub-portions to remove, and the XR device may remove the suggested sub-portions from the image, compress the image, and transmit the compressed image to the receiving device. In some cases, the XR device may use RF sensing to determine which portion(s) of an image to remove (e.g., portions without blockages). In some examples, high frequency RF signals such as signals using a sub-THz band (such as a band having a wavelength of 2 millimeters (mm) for a 145 GHz carrier), may be used to construct a fine-detail map of the environment, thereby increasing image compression accuracy.

Aspects of the disclosure are initially described in the context of wireless communications systems. Aspects of the disclosure are further illustrated by and described with reference to GANs, process flows, apparatus diagrams, system diagrams, and flowcharts that relate to communication and sensing of physical level image compression. Physical level image compression may refer to image compression and signaling using physical channels of a wireless communications protocol.

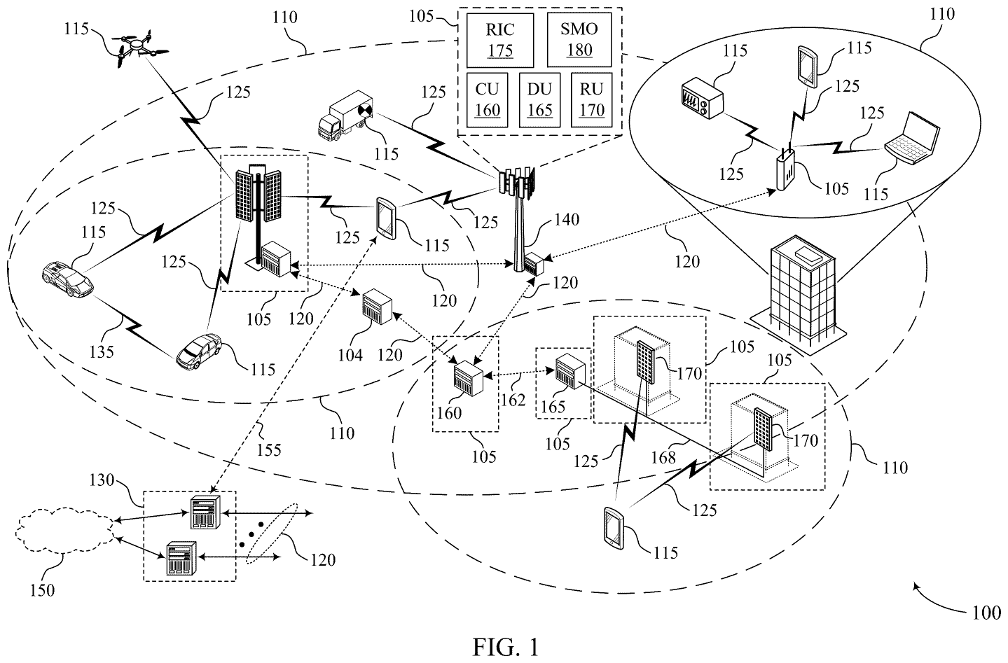

FIG. 1 shows an example of a wireless communications system 100 that supports communication and sensing of physical level image compression in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include XR devices (e.g., XR UEs 115). Processing and communication loads for such XR devices may result in some functions being offloaded from the XR device to another UE 115 (for example, a UE 115 of the user of the XR device), or to a network entity 105. One example of such offloading includes image processing where an image (e.g., a single image or images of a video) taken by the XR device is relayed to the UE 115 (or the network entity 105) for processing (e.g., for pattern/object recognition to determine useful environmental augmentation information). However, the amount of data used to communicate the image (or images or video) from the XR device to the UE 115 (or the network entity 105) may be extensive, resulting in image compression techniques being applied to the image before transmission. Some XR devices may implement inpainting techniques via which a portion of the image data is removed prior to transmission and then reconstructed by the receiving device, for example, via use of a GAN employed by the receiving device.

For example, an XR UE 115 (e.g., an XR device) may transmit an indication of one or more masking parameters associated with an inpainting scheme to a receiving device (e.g., another UE 115 and/or a network entity 105). The XR UE 115 may remove, according to the one or more masking parameters of the inpainting scheme, a portion of image data from an image to obtain a masked image. The masked image may have a smaller amount of image data than the image (e.g., as a portion of the image data is removed). The XR UE 115 may compress, according to a compression scheme, the masked image to obtain a compressed image. The compressed image may have smaller amount of image data than the masked image based on the compression. The XR UE 115 may transmit the compressed image to the receiving device, such as via a physical sidelink shared channel (PSSCH), a physical uplink shared channel (PUSCH), or another physical layer channel.

A receiving device (e.g., a UE 115 and/or a network entity 105) may receive an indication of one or more masking parameters for an inpainting scheme for an XR UE 115. The receiving device may receive a compressed image from the XR UE 115 via a physical layer channel. The receiving device may decompress, according to a compression scheme, the compressed image to obtain a masked image. The receiving device may reconstruct, according to the one or more masking parameters for the inpainting scheme, an image from the masked image. The inpainting scheme may generate a mask portion of the masked image that recreates the image when combined with the masked image. In inpainting schemes, inpainting of future frames may be performed based on some previously seen frames provided as input to the inpainting machine/algorithm, while estimating movement of pixels. Thus, sudden object insertion in a masked area may not properly be reconstructed.

RF sensing of an environment may be used to supplement inpainting based compression as RF sensing may be used to detect blockages and/or objects behind blockages. For example, a UE 115 (e.g., an XR UE 115) may transmit an indication of a portion of an image that the UE 115 intends to remove as part of the inpainting scheme. The receiving device may sense the environment of the image using RF signals to determine whether the UE 115 is to remove the indicated portion of the image and/or which sub-portions of the portion for the UE 115 to remove (e.g., based on blockages in the portion with respect to a field of view of the camera of the UE 115). The receiving device may transmit an indication of the suggested sub-portions to remove, and the UE 115 may remove the suggested sub-portions from the image, compress the image, and transmit the compressed image. In some cases, the UE 115 may use RF sensing to determine which portion(s) of an image to remove (e.g., portions without blockages). The receiving device may input RF sensing data to the inpainting model (e.g., the GAN) in addition to the masked image to improve the accuracy of the image reconstruction using the inpainting model (e.g., by providing position data for blockages and/or objects behind blockages).

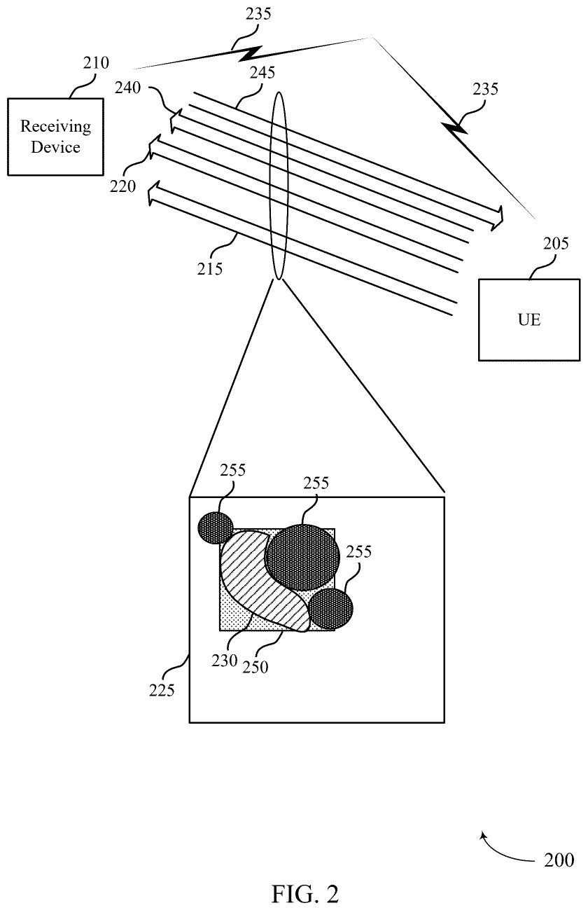

FIG. 2 shows an example of a wireless communications system 200 that supports communication and sensing of physical level image compression in accordance with one or more aspects of the present disclosure. The wireless communications system 200 may implement or may be implemented by aspects of the wireless communications system 100. The wireless communications system 200 may include a UE 205 and/or a receiving device 210, which may be examples of the corresponding devices described herein. For example, the UE 205 may be an example of an XR device (e.g., an XR UE 115), and the receiving device 210 may be an example of a UE 115 (e.g., associated with the UE 205) and/or a network entity 105.

XR technology (e.g., virtual reality (VR), augmented reality (AR), mixed reality (MR), or similar technologies) may be utilized by the wireless communications system 200. XR technology may be adopted for applications such as gaming, healthcare, education, social, retail, and more. Such applications may be supported by a user wearing one or more devices that collect data and images around the user, process this information, and then render additional information (e.g., overlay text, image, and more, onto the user's surroundings). Examples of XR devices may include glasses or head mounted displays (HMDs), watches, earphones, other wearable devices, or any other device capable of collecting user data and/or communicating via wireless communications system 200. In the non-limiting example illustrated in FIG. 2, the UE 205 may be considered an XR device while the receiving device 210 may be considered a UE 115 or a network entity 105 associated with the user.

The UE 205, the XR device in this example, may include sensor(s), such as camera(s). The camera(s) capture images (e.g., still images, videos, and/or still image(s) from a video) of the environment and/or track the eye movements of the user (e.g., to determine the user's field of view). The image(s) are then processed to identify or otherwise quantify the user's surroundings in order to render the additional information. However, such intensive processing may consume considerable power of the XR device. To mitigate the power consumption associated with XR technology, some XR devices may configure the sensors to operate in a low power mode. For example, the XR device may lower the frames-per-second (FPS) rate of captured video, reduce the resolution of the image captured by the camera(s), reduce the sampling rate of the surroundings, and more, alone or in combination.

Another technique to optimize XR device performance and efficiency may be to offload the processing (and associated power consumption) load onto another device, such as the UE associated with the XR device and/or directly to the network (e.g., to the receiving device 210). In this approach, the UE 205 may compress the image(s) before transmission to the receiving device 210. For example, the XR device (e.g., the UE 205) may compress the output of the camera(s) using a compression scheme (e.g., H264, H265, or other compression schemes) to reduce the payload size before transmission. Such compression schemes are adopted to provide high quality/low latency video transmission from the XR device to the receiving device 210 for processing. Additionally, the XR device may communicate the image data to the receiving device 210 via a physical channel to further reduce latency and improve efficiency.

However, while such compression techniques are helpful, the amount of image data to be communicated from the XR device to the receiving device 210 may continue to be significant and may consume significant resources of the wireless network, the XR device, and/or the receiving device 210. Thus, additional techniques to remove the amount of image data being communicated between the XR device (e.g., the UE 205) and the receiving device 210 may be used.

Accordingly, aspects of the techniques described herein include an inpainting scheme applied to the image(s) being communicated from the UE 205 to the receiving device 210. Broadly, an inpainting scheme may be a conservation process where missing parts of an image (e.g., some of the image data has been removed or masked) are regenerated or otherwise reconstructed to provide a complete image. The inpainting scheme may reconstruct the original image (e.g., approximate and add the removed image data to restore the original image) based on the surroundings and features of the missing parts. The inpainting scheme may be implemented using machine learning algorithms, such as a GAN. However, other models also may be used for the inpainting scheme. Accordingly, aspects of the techniques described herein further enhance image compression based on the transmitting device (e.g., the XR device, which is the UE 205 in this example) compressing and removing part(s) of the image features and the receiving device 210 decompressing and reconstructing the missing parts according to the inpainting scheme.

The inpainting scheme may be based on various masking parameter(s). For example, the inpainting scheme may involve use of a GAN which may be trained using different masks at different locations and shapes within training images/video frames. The masking parameters may define various aspects of the portion of the image data that are removed before transmission to the receiving device 210. That is, the image(s) are generally represented by image data that is communicated from the UE 205 to the receiving device 210. The UE 205 may, according to the masking parameters, remove a masked portion of the image, remove a set of masked portions from each image within a set or group of images, and/or remove frame image(s) from a video. In some examples, the masking parameter(s) may identify the region or area within the image that was removed. The masking parameter(s) may be applied to the image itself or within a field-of-view region of the image (e.g., the user's field-of-view). Removing the portion of the image data reduces the amount of image data of the image. That is, applying the masking parameters (e.g., removing the portion of the image data) to the image may reduce the total amount of image data communicated from the UE 205 to the receiving device 210.

Accordingly, at 215 the UE 205 may transmit or otherwise provide (and the receiving device 210 may receive or otherwise obtain) an indication of the masking parameter(s) associated with the inpainting scheme. For example, the UE 205 may obtain or otherwise collect an image 225 (e.g., via sensor(s), such as cameras of the XR device). The masking parameters indicated to the receiving device 210 may signal or otherwise identify information to be used in the inpainting scheme to reconstruct the original image by the receiving device 210. For example, the masking parameter(s) may include an information associated with or otherwise indicating the mask region(s), the mask shape(s), the mask size(s), the mask locations (e.g., within the image), and other related information to the receiving device 210. In some examples, the masking parameter(s) may include a mask periodicity (e.g., whether the same mask applied for consecutive frames and/or until updated).

In some examples, the masking parameter(s) may include an index or other identifying information for a mask selected out of a (pre) defined set of masks (e.g., free-form mask or different known shapes). For example, the receiving device 210 may transmit or otherwise provide (and the UE 205 may receive or otherwise obtain) a signal indicating or otherwise identifying a set of available inpainting schemes associated with the receiving device 210. The masking parameter(s) indicated at 215 may carry or otherwise convey an indication of a selected inpainting scheme of the set of available inpainting schemes. The selected inpainting scheme may be associated with a known or (pre) configured set of masking parameter(s) such that indicating the selected inpainting scheme identifies the associated masking parameters. Additionally, or alternatively, the selected inpainting scheme indicated in the masking parameter(s) may identify or otherwise indicate the masking parameter(s) to be applied during the inpainting operations.

The UE 205 may remove, according to the masking parameter(s), a portion of the image data from the image to obtain a masked image. As one non-limiting example, the portion of the image removed may correspond to a mask 230. For example, the UE 205 may remove (e.g., filter or otherwise delete) the image data from the image corresponding to the area identified by the mask 230. The image 225, after the portion of the image data corresponding to the mask 230 is removed, may be referred to as a masked image.

The UE 205 may also compress the masked image to obtain a compressed image according to a compression scheme (e.g., H264/H265). Compressing the masked image to obtain the compressed image further reduces the amount of image data (e.g., relative to the masked image). For example, applying the mask 230 to remove the portion of the image data to obtain a masked image and then compressing the masked image provides two levels of image data reduction to the image(s) to be communicated to the receiving device 210, which further improves the efficiency of the XR techniques.

At 220, the UE 205 may transmit or otherwise provide (and the receiving device 210 may receive or otherwise obtain) the compressed image via a physical layer channel, such as a PSSCH, PUSCH, or another physical channel. The receiving device 210 may decompress the image according to the compression scheme to recover or otherwise obtain the masked image. The receiving device 210 may reconstruct the image from the masked image according to the masking parameter(s) for the inpainting scheme. For example, the receiving device 210 may use the inpainting scheme to generate the mask portion of the masked image (e.g., based on mask 230, which may correspond to the masking parameter(s)).

Accordingly, aspects of the techniques described herein utilize inpainting (or other machine learning models) techniques where image/video editing (e.g., text/object removal and reconstruction) are applied. Applying the inpainting scheme to the communicated image(s) may increase the image compression factor ratio of the actual image relative to the image that is transmitted to the receiving device (e.g., from the UE 205 to the receiving device 210). The UE 205 may drop or otherwise remove some part of (e.g., at least a portion of) the image or video, where the portion to be removed may be used by the machine learning model (e.g., the inpainting scheme) that captures or otherwise uses correlated regions of an image or video such that the receiving device 210 is trained on the correlated regions. The transmitting side (e.g., the UE 205), after removing the portion of the image or video, may perform compression and then transmit the compressed image to the receiving device 210. The receiving device 210 may decompress the image (e.g., at least the portions of the image that were not removed before being communicated) and then apply the inpainting scheme to reconstruct the missing parts of the image. For example, the receiving device 210 may generate a mask portion corresponding to the mask 230 of the masked image to recreate or reconstruct the image (e.g., when combined with the masked image).

Dropping or removing part of the image may result in increasing the overall compression factor for the transmitted image (e.g., the compressed image) relative to techniques that do not apply inpainting techniques. Although the examples discussed herein generally cover an uplink example (e.g., XR device-to-UE and/or network entity), the techniques may also be applicable to a downlink example (e.g., network entity and/or UE-to-XR device).

As described herein, the enhanced compression scheme (e.g., compression and inpainting) may be applied to an entire image or to a field of view within the image (e.g., to reduce transmission overhead). The mask may also be referred to as the region to inpaint, and accordingly may be the region removed from the image. In some examples, the mask may be selected using a known neural network (NN). For example, a residual neural network (ResNet) may use first several layers of the NN for feature extraction and may use the extracted features to perform parameter correlation. A ResNet may use mean-square error (MSE) or cross-entropy metrics for the determination of which portion of the image to remove and the corresponding position of the portion within the image. In some examples, the mask may be selected using a spatial correlation metric to determine a relevant segment of the image. In some examples, the mask may be selected using a known NN that performs segmentation, such as a convolutional NN (CNN), a Pyramid Scene Parsing Network (PSPNet), or a U-Net. In some examples, the mask may be predefined using an NN or based on a suggestion from the receiving device 210 (e.g., based on feedback from the receiving device 210 or based on feedback from the network (e.g., from a network entity)). In some examples, the masked portion of an image may be standardized (e.g., the parameters for mask selection may be standardized, such as if a portion of an image changes by less than a threshold amount between subsequent frames or images). The masking may be applied to an entire frame out of a video (e.g., effectively reducing the FPS and receive-side inpainting). To support cross-layer optimization for power consumption, latency, and improve communications, the compressed image may be transmitted from the UE 205 to the receiving device 210 via the physical layer channel.

In some aspects, the inpainting scheme (e.g., model) may be trained (e.g., between the UE 205 and the receiving device 210). For example, the UE 205 and the receiving device 210 may communicate (e.g., exchange one or more messages) to train the inpainting scheme (e.g., train the model used for the inpainting scheme). The training process may optimize the inpainting scheme to further improve image reconstruction by the receiving device 210. For example, the entire model (e.g., the model for the inpainting scheme) may be trained (e.g., online or offline, beforehand or as part of the inpainting scheme application). In some examples, the model training may be trained beforehand (e.g., offline) between the UE 205 and the receiving device 210. Additionally, or alternatively, the UE 205 and the receiving device 210 may perform fine-tuning training online (e.g., while performing the inpainting scheme).

In some examples, such training may include various model related signaling, which may be provided via RRC signaling, medium access control-control element (MAC-CE) signaling, or other signaling (e.g., higher layer signaling). Broadly, the model related signaling may identify, define, or otherwise be used to activate or deactivate the (or a specific) inpainting scheme, update various parameter(s) associated with the inpainting scheme, various capability signaling, and more. Model related signaling via RRC, MAC-CE, or other higher layer signaling may be different from the physical layer signaling used to carry or otherwise convey the masked and compressed image.

Physical layer signaling may be transmitted over a control channel on the physical layer. Examples of control channels on the physical layer include Physical Downlink Control Channel (PDCCH) on the downlink and Physical Uplink Control Channel (PUCCH) on the uplink in LTE or 5G (NR). Model related signaling may be encoded as Downlink Control Information (DCI) carried in PDCCH or Uplink Control Information (UCI) carried in PUCCH. The encoding may employ various channel coding schemes. Examples of channel coding schemes including Turbo Codes, Polar Codes and Low-Density Parity Check (LDPC) Codes. The length for model based signaling may vary according to the information in the signaling. Encoding by Polar Codes may be subject to the constraint of length of power of 2, but padding bits can be added to information bits for the model related signaling. Other coding schemes such as convolutional codes and block codes can be employed for lower decoding complexity. The same encoder can be used for all sizes of the model related signaling where techniques of rate-matching can adapt the length of the coded signaling message to fit the physical channel condition. HARQ may be employed to realize retransmissions of messages on the physical layer to reduce latency associated with retransmissions.

One non-limiting example of such model related signaling may be used to update the model weights. That is, various masking parameter(s) associated with the inpainting scheme may be applied on an absolute basis (e.g., according to a determined value) and/or may be applied using a weighting factor (e.g., the weighting factor may increase or decrease the relevance of the parameter within the inpainting scheme). The UE 205 and/or the receiving device 210 may update various model weighting factors of the inpainting scheme (e.g., during a training process and/or separate from the training process). For example, the UE 205 may transmit or otherwise convey (and the receiving device 210 may receive or otherwise obtain) an updated model weighting factor to be applied for the inpainting scheme. Additionally, or alternatively, the receiving device 210 may transmit or otherwise convey (and the UE 205 may receive or otherwise obtain) an updated model weighting factor to be applied during the inpainting scheme.

Additionally, or alternatively, in some examples the weighting factors may be updated during the training process. For example, updated model parameter(s) may be communicated from the UE 205 and/or from the receiving device 210 that indicates or otherwise identifies various updated model parameter(s). Examples of the updated model parameter(s) include, but are not limited to, the updated model weighting factors, a subset of the layers of the inpainting scheme to be trained, updating the loss function of the model (e.g., the GAN loss function), information identifying the sensor(s) of the UE 205 associated with the training and/or with the inpainting scheme operations, and more. In some examples, the weighting factors may be pre-trained by the UE 205, may be pre-trained by a network entity 105, and/or may be standardized. For example, pre-training may be performed using a known set of images, for example, using an NN. In some examples, training may be performed between a network entity 105 collaborating with a UE 205. For example, the network entity 105 may signal to the UE 205 to train specific scenarios captured by the camera(s) of the UE 205. In some examples, the UE 205 may perform training without input from the network entity 105 or a receiving device 210, and the UE 115 may transmit signaling to the network entity 105 or receiving device 210 that indicates the trained weighted models to the network entity 105 or receiving device 210. In some examples, the training may be performed until reaching some threshold image quality metrics, such as threshold peak signal-to-noise ratio (PSNR), a threshold structural similarity index measure (SSIM), or a threshold perceived image quality. Such thresholds may be defined for a given image quality. In some examples, the network entity 105 may signal (e.g., to the receiving device 210 and/or the UE 205), relevant threshold image quality metrics, and the receiving device 210 and/or the UE 205 may re-initiate a training process when image quality falls below the relevant threshold image quality metrics.

In some examples, the signaling related to the UE 205 performing online model training to update the model weighting factors may be combined with a report from the UE 205 on the updated weights. For example, the report may include GAN updated weights, may use sub-signaling related to only a few layers of the model for the retraining, may include signaling related on training the model with different loss functions, and/or may include signaling related to which set of sensors/cameras the inpainting is done (in some examples this can go into or otherwise be part of a larger set of model(s) that combines spatial inpainting models).

Another example of the model related signaling may include an indication of which model (e.g., which inpainting scheme) is to be applied. For example, the UE 205 may transmit or otherwise convey (and the receiving device 210 may receive or otherwise obtain) an indication of a preferred inpainting scheme that will be applied to the masked image. Additionally, or alternatively, the receiving device 210 may transmit or otherwise provide (and the UE 205 may receive or otherwise obtain) an indication of a preferred inpainting scheme that will be applied to the masked image. This may support the receiving device 210 implementing a set of models (e.g., a set of available inpainting schemes) and the UE 205 may signal or otherwise indicate which model to work on or apply. This may support the UE 205 and the receiving device 210 (pre) configuring for a specific (e.g., an achievable) compression factor in terms of complexity and latency. For example, a large model may demand more complexity, but may also result in an improved compression factor and inpainting recovery (e.g., image reconstruction).

Another example of such model related signaling may be capability-based. For example, the UE 205 may transmit or otherwise provide (and the receiving device 210 may receive or otherwise obtain) information indicating or otherwise identifying an image masking capability of the UE 205. The image masking capability may include information identifying a supported and/or selected FPS, resolution reduction, and or other related information. This may support the UE 205 and the receiving device 210 skipping or otherwise changing the model feature layers of the inpainting scheme. Additionally, or alternatively, the UE 205 may choose between different types of models that are optimized for each supported capability. By way of non-limiting example, reducing the FPS but increasing spatial resolution might project on different model implementations that are best suited for temporal resolution increases to overcome the FPS reduction, or vice versa.

Another example of such model related signaling may include turning the inpainting scheme on or off. For example, the UE 205 and the receiving device 210 may exchange signaling indicating whether to perform inpainting or to apply removal of part(s) of images in accordance with the inpainting. For example, the UE 205 may transmit or otherwise provide (and the receiving device 210 may receive or otherwise obtain), or vice versa, an activation message initiating the inpainting scheme for the image and/or for multiple images (e.g., according to the periodicity of the inpainting scheme).

Accordingly, the UE 205 and the receiving device 210 may exchange various signaling to train, select, and/or activate/deactivate the inpainting scheme (e.g., the model) to be applied to the compressed image. For example, the receiving device 210 may reconstruct the image 225 by combining the mask portion of the masked image (e.g., the portion corresponding to mask 230) and the masked image (e.g., the original, decompressed image minus the mask portion) according to the inpainting scheme.

In some examples, the UE 205 and/or the receiving device 210 may implement RF sensing to improve compression and/or inpainting. RF signals 235 may have good characteristics for tracking and environment estimation, such as radar and sensing. The UE 205 and the receiving device 210 may use RF signals 235 (e.g., Wi-Fi signals, LTE signals, 5G NR signals, ultra-wideband (UWB) signals, Bluetooth signals) for communication (e.g., for communications at 215 or 220). RF signals may not be used for color detection, but other sensors (e.g., cameras, X-Rays) may be used for color detection. The UE 205 and/or the receiving device 210 may sense the environment associated with the image 225 using RF signaling equipped for communications (e.g., Wi-Fi, 5G NR, UWB, Bluetooth). For example, the UE 205 and/or the receiving device 210 may detect objects within the environment based on reflections of RF signals off the objects (e.g., based on measurements of reflections of the RF signals). The RF signals 235 may be combined with inpainting models to enhance the inpainting models. For example, RF signals 235 may be used for radar and sensing purposes (e.g., to calculate the distance between the transmission/reception antennas of the UE 205 or the receiving device 210 and an object in the environment off of which an RF signal reflects). For example, RF sensing may be used for blockage inpainting or image/video reconstruction (e.g., especially for inpainting the next frame prediction of images/frames) to improve overall inpainting models.

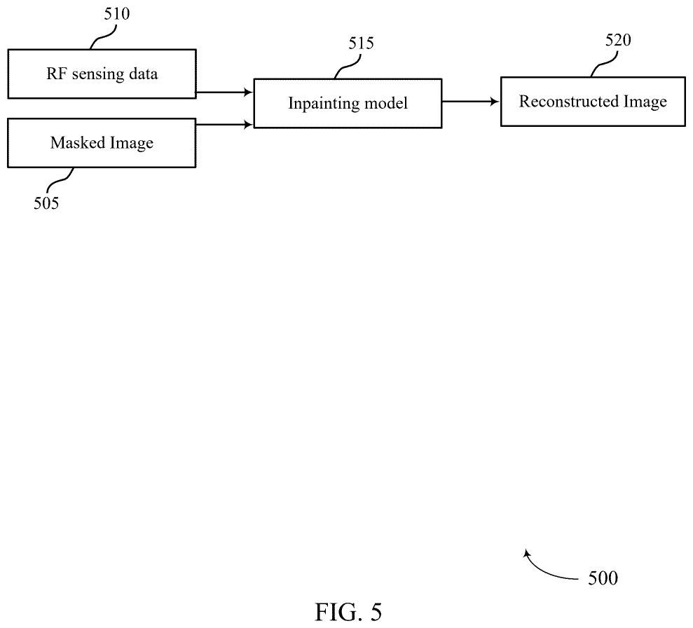

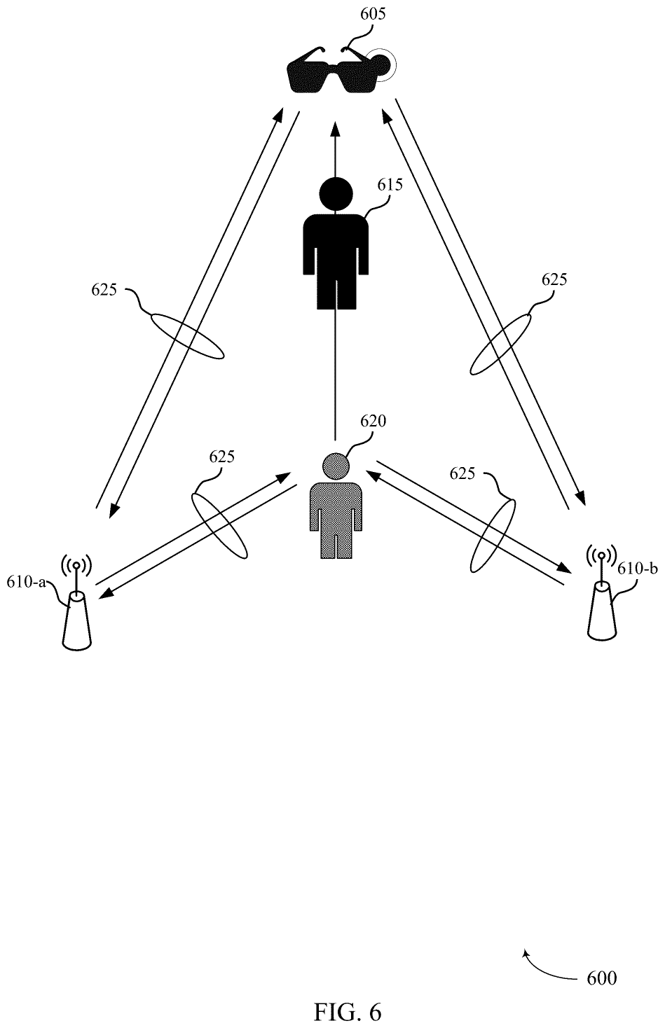

Inpainting models may be trained on all visual data for the masked area reconstruction as described herein. Further, inpainting of future frames may be performed using previous frames as input to the inpainting AI model (e.g., the GAN) while estimating movement of pixels. Thus, a sudden object insertions within an upcoming frame may not be properly reconstructed if the inserted object was not present in the prior frames, absent other sensing of the object. Thus, inpainting models may fail with the existence of blockages, as artificial intelligence (AI) based inpainting models such as a GAN may not foresee the movement of the objects behind the blockages. The UE 205 or the receiving device 210 may use the RF signals 235 to detect objects within the environment and potential blockages, as described with reference to FIGS. 5 and 6. Combining such RF sensing information with inpainting models may increase the prediction accuracy of the inpainting models for sudden object insertion and/or moving objects (or a moving field of view of the camera). For example, RF sensing may be combined with inpainting models via using the RF sensing information as an input to the AI model (e.g., to an NN or GAN). Accordingly, the AI model may perform feature extraction from the image using both the image and the RF signals. Similar, the RF sensor data may be input to the NN used to decode the masked image.

In some examples, RF sensing may be used to determine whether to remove a portion of the image 225. For example, at 240, the UE 205 may transmit an indication of a portion 250 of the image 225 that the UE 205 intends to remove in accordance with the inpainting scheme. The receiving device 210 may perform RF sensing of the environment of the image 225 using the RF signals 235, and the receiving device 210 may detect the position of one or more objects in the environment based on the RF sensing. For example, the receiving device 210 may sense one or more objects 255. Based on the one or more objects 255, the receiving device 210 may determine a subset of the portion 250 of the image 225 that the UE 205 may remove. For example, the receiving device 210 may determine for the UE 205 not to remove portions that correspond to blockages. At 245 the receiving device 210 may transmit an indication of the subset of the portion 250 of the image 225 that the UE 205 may remove. For example, the subset of the portion 250 may correspond to the mask 230. The UE 205 may correspondingly remove the portion of the image that corresponds to the mask 230 as described herein.

For example, RF sensing using the RF signals 235 may be performed by calculating metrics for the RF signals 235 used for sensing such as Received Signal Strength Indicator (RSSI), angle of arrival (AoA), time distance of arrival (TDoA), angle of departure (AoD), and/or triangulation. Such methods may be used to measure the environment (e.g., to sense the position of objects in the environment) via measuring the angles of reflections and the amplitude of reflections of the RF signals 235 off of objects within the environment. As RF signals 235 may be commonly used and widespread throughout the environment (e.g., for Wi-Fi, LTE communications, 5G NR communications, UWB communications, Bluetooth), the RF signals 235 may be reflected off multiple scattering objects, and thus the one or more objects 255 may be detected. For example, RF metrics based on an RF signal 235 that may be input to an encoder for inpainting may include the RF signal itself, the RSSI of the RF signal 235, and/or other measured features of the RF signal 235. For example, an NN used in the decoder may be standardized, pre-trained, or trained using RF signal metrics as an input. For example, the NN may be based on reinforcement learning with the score of perceived image quality as reinforcement.

Higher frequency bands of RF signals 235, such as frequency range two (FR2) (e.g., 24.25 GHz to 52.6 GHz) or sub-THz (e.g., 100 GHz to 350 GHz) may be used to improve sensing of the environment. For example, the smaller wavelength of higher frequency RF bands may be used to sense finer details of objects of the environment. For example, a subTHz RF signal may have a wavelength of 2 millimeters (mms) for a 145 GHz carrier, which can be used to both detect motion of objects and to provide finer details of the objects which can be infused into the inpainting model. Sensing of fine details of objects may provide an increased level of detail to the inpainting model and may provide finer resolution of the blocked/missing elements in the transmitted image. As another example, using higher frequency RF bands for environment sensing may allow the UE 205 or the receiving device 210 to control the amount of sensing demanded and to focus the sensing on areas which are the most important for the inpainting model, which in turn may allow for better compression and less image processing at the UE 205.

In some examples, RF sensing using RF signals 235 may be used with inpainting in the UE 205 (e.g., XR goggles or another XR UE 115) and the receiving device 210 (e.g., a UE 115 or a network entity 105) for both downlink and uplink purposes. For example, the UE 205 and/or the receiving device 210 may estimate sensing parameters such as AoA, AoD, RSSI, TDoA of RF signals 235 and may map the environment associated with the image 225 based on the sensed parameters.

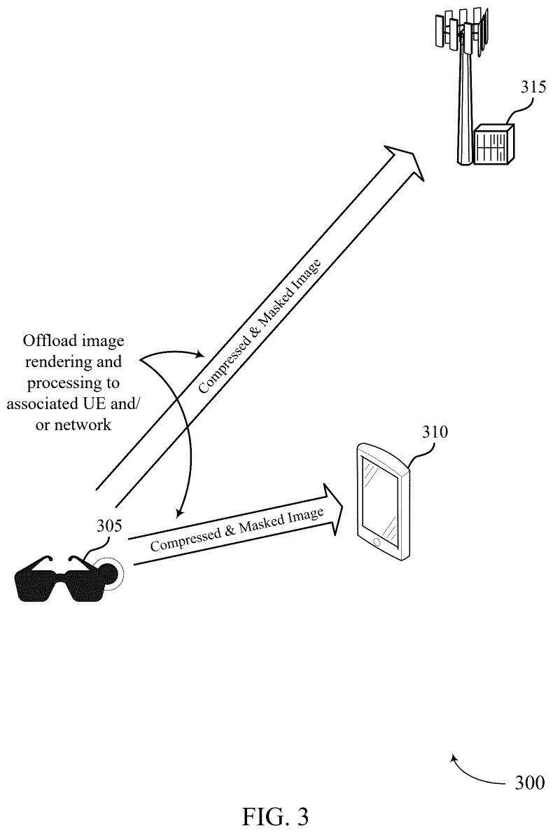

FIG. 3 shows an example of a wireless communications system 300 that supports communication and sensing of physical level image compression in accordance with one or more aspects of the present disclosure. The wireless communications system 300 may include a XR device 305, a UE 310, and a network entity 315, which may be examples of the corresponding devices described herein. For example, the XR device 305 may be an example of a UE 115 (e.g., a wearable device, such as an IoT device) and the UE 310 may be an example of a UE 115 of the user of the XR device 305. The network entity 315 may be an example of a serving network entity or cell associated with the XR device 305 and the UE 310.

As discussed above, aspects of the techniques described herein provide for inpainting and compression of image(s) transmitted from a UE (e.g., the XR device 305, in this example) to an associated UE (e.g., the UE 310, in this example) and/or to a network entity (e.g., the network entity 315, in this example). For example, the XR device 305 may transmit an indication of masking parameter(s) associated with an inpainting scheme to a receiving device. The receiving device in this example may be the UE 310 and/or may be the network entity 315. The masking parameter(s) may generally define, at least to some degree, a portion of image data (e.g., corresponding to a portion of the image) that is masked or otherwise removed from the image to obtain a masked image. That is, the XR device 305 may capture or otherwise obtain image(s) (e.g., individual image(s), image(s) within a video, and/or a portion of image(s) corresponding to a field-of-view). The XR device 305 may remove the portion of the image according to an inpainting scheme. The XR device 305 may also compress the masked image using various compression schemes (e.g., to obtain a compressed image of the masked image). Removing the portion of the image according to the masking parameter(s) of the inpainting scheme generally reduces the amount of image data of the image. Compressing the masked image further reduces the amount of image data. Combined (e.g., inpainting and compression), the schemes result to reduce the amount of image data that is communicated to the receiving device.

The XR device 305 may transmit or otherwise provide the compressed image to the receiving device, such as over the physical layer channel. The receiving device (e.g., the UE 310 and/or the network entity 315) may decompress the compressed image (e.g., reconstruct the masked image) and then reconstruct the image from the masked image according to the inpainting scheme. The reconstructed image may be used for various XR related functions, such as analysis of the image in support of augmenting the reality of the user (e.g., via the XR device 305, which may be a set of glasses or goggles worn by the user). As discussed in more detail below, this may include the receiving device implementing a GAN to reconstruct the image according to the inpainting scheme.

Accordingly, wireless communications system 300 illustrates a non-limiting example of utilizing inpainting in combination with compression techniques for image processing in support of augmented reality and/or environmental detection and identification operations. FIG. 3 illustrates an example where the XR device 305 offloads or otherwise transfers at least part of the XR functionality (e.g., processing related to at least the image reconstruction to reduce complexity and power consumption of the XR device 305. The described techniques further improve the efficiency of such offloading operations in the context of XR functionality to the network (e.g., the network entity 315) and/or to an associated UE (e.g., the UE 310).

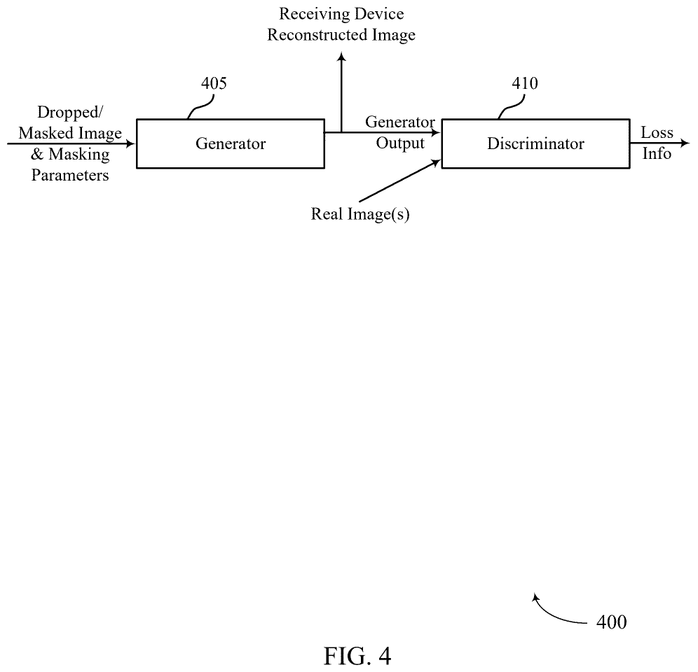

FIG. 4 shows an example of a GAN 400 that supports communication and sensing of physical level image compression in accordance with one or more aspects of the present disclosure. Aspects of GAN 400 may implement and/or be implemented by wireless communications system 100, wireless communications system 200 and/or wireless communications system 300. Aspects of GAN 400 may be implemented at or implemented by a UE 115 (e.g., an XR device), a UE 115 associated the XR device, and/or a network entity 105, which may be examples of the corresponding devices described herein. For example, the XR device may be an example of a UE 115 (e.g., a wearable device, such as an IoT device) and the associated UE 115 may be an example of a UE 115 of the user of the XR device. The network entity 105 may be an example of a serving network entity or cell associated with the XR device and the associated UE. Broadly, the GAN 400 may include a generator 405 and/or a discriminator 410. For example, a GAN, such as the GAN 400, may be a generative model that includes a generator and a discriminator, where the generator learns to generate plausible data and the discriminator learns to distinguish the generator's fake data from real data.

As discussed above, aspects of the techniques described herein provide for inpainting and compression of image(s) transmitted from the XR device to an associated UE and/or to a network entity. For example, the XR device may transmit an indication of masking parameter(s) associated with an inpainting scheme to a receiving device. The receiving device in this example may be the associated UE and/or may be the network entity. Aspects of GAN 400 may be implemented at or implemented by the associated UE and/or the network entity (e.g., implemented locally at one or both devices and/or implemented remotely in coordination with one or both devices). The masking parameter(s) may generally define, at least to some degree, a portion of image data (e.g., corresponding to a portion of the image) that is masked or otherwise removed from the image to obtain a masked image.

That is, the XR device may capture or otherwise obtain image(s) (e.g., individual image(s), image(s) within a video, and/or a portion of image(s) corresponding to a field-of-view). The XR device may remove the portion of the image according to an inpainting scheme (e.g., based on the masking parameter(s)). The XR device may also compress the masked image using various compression schemes (e.g., to obtain a compressed image of the masked image). Removing the portion of the image according to the masking parameter(s) of the inpainting scheme generally reduces the amount of image data of the image. Compressing the masked image further reduces the amount of image data. Combined (e.g., inpainting and compression), the schemes result to improve reduction of the amount of image data that is communicated to the receiving device.

The XR device may transmit or otherwise provide the compressed image to the receiving device, such as over a physical layer channel (e.g., PSSCH, PUSCH, or another physical layer channel). The receiving device may decompress the compressed image (e.g., reconstruct the masked image) and then reconstruct the image from the masked image according to the inpainting scheme. The reconstructed image may be used for various XR related functions, such as analysis of the image in support of augmenting the reality of the user (e.g., via the XR device, which may be a set of glasses or goggles worn by the user).

Although the techniques described herein are illustrated in the context of an inpainting scheme based on GAN 400, it is to be understood that these techniques are not limited to inpainting schemes and/or to utilization of a GAN. Instead, other models may be utilized to reconstruct the original image from the masked and compressed image, which may utilize a GAN architecture and/or may utilize other learning models. Accordingly, the discussion below relating to inpainting and/or GAN 400 are provided by way of non-limiting example only. As another example, reinforcement learning may be used instead of or in addition to a GAN 400. For example, reinforcement learning may be used where the reinforcement score is a threshold PSNR, SSIM, or perceived image quality, and an NN may determine whether and/or which mask portions to remove from an image based on the threshold PSNR, SSIM, or perceived image quality. For example, feature extraction may be performed by a pre-trained NN. As another example, an NN that performs feature extraction may be trained with online using the threshold PSNR, SSIM, or perceived image quality.

GANs, such as GAN 400, are generative models that create new instances that resemble the training dataset. An example GAN may be described in Advanced Courses: Generative Adversarial Networks, by Google Machine Learning Education, available at https://developers.google.com/machine-learning/gan, which is incorporated by reference in its entirety. The two neural nets (e.g., the generator 405 and the discriminator 410) compete, where the gain of one is the loss of the other. The functionality of a GAN is based on “indirect” training through the discriminator 410, which tells or otherwise decides how “realistic” the input seems. The generator 405 is not trained to minimize the distance to a specific image, but rather to fool the discriminator 410. That is, the generator 405 generates new data instances (images, in this example) where the generated data (again, image in this example) becomes negative training examples for the discriminator 410. The discriminator 410 learns (e.g., is trained) to distinguish between fake data and real data output from the generator 405. For example, the discriminator 410 penalizes the generator 405 for producing implausible results.

As discussed above, aspects of the techniques described herein may include training the inpainting scheme. To some degree, this may include training the GAN 400. To train a general GAN, the generator 405 produces obviously fake data, and the discriminator 410 quickly learns to tell that such data is fake (which would be a loss for the generator 405). As the training progresses, the generator 405 gets closer and closer to producing output that can fool the discriminator 410 (which would be a loss for the discriminator 410). Finally, if the generator 405 training goes well, the discriminator 410 gets worse at telling the difference between real or fake, and the accuracy of the discriminator 410 decreases.

More particularly, part of the training process is for the GAN to try to replicate a probability distribution using a loss function that reflects the distance between the distribution of the generated data and the real data. A GAN can have two loss functions, one for the generator 405 training and one for the discriminator 410 training. A minimal loss function may be represented by:

$${E}_{x ∼ {P}_{data} ( x )} [ log ( D ( x ) ) ] + {E}_{z ∼ {P}_{z} ( z )} [ log ( 1 - D ( G ( z ) ) ) ]$$

where D(x) is the Discriminator's estimate of the probability that real data instance x is real, E_{x˜P}_{_{data}}₍ₓ₎ is the expected value over all real data instances, G(z) is the Generator's output when given random input z, D(G(z)) is the Discriminator's estimate of the probability that a fake instance is real, and E_{z˜P}_{_{z}}_{(z)} is the expected value over all random inputs to the Generator (in effect, the expected value over all generated fake instances G(z)). The generator 405 cannot directly affect the log (D(x)) term in the function is for the generator 405 where minimizing the loss is equivalent to minimizing log (1−D(G(z))) In some examples, the generator 405 loss may be modified so that the generator 405 tries to maximize log (D(G(z))).

GANs may use image(s) as the data set(s) during the training process. For example, as part of a machine learning algorithmic approach the model may be trained at first on a diverse dataset of images/video frames, as well as different masks at different locations and shapes within the images/video frames. The inpainting training input may use various data for training the machine learning model. For example, the input to the generator 405 may be the image(s) (e.g., image data) of the images/video frames that are used for the model to train on a real (e.g., known) dataset. The input to the generator 405 may also include the masked data, such as the masking parameter(s). In some examples, the input may include an indication of and/or information associated with the mask itself, such as the location and shape of the applied mask. In the context of inpainting schemes, the masked/removed pixels (e.g., the portion of the image data) represents the enhanced compression factor on top of the legacy compression schemes applied to the rest of the image/video. In some examples, the mask location may be unknown and therefore the network may learn or be trained on various mask shapes/locations. In some aspects of the training, the real image(s) may also be provided to the discriminator 410 in order to improve the generator 405 output. The receiving device may use the generator output as the recovered data (e.g., the reconstructed image(s), in this example).

There may be many inpainting models available that may be applied in accordance with the techniques described herein. In some examples, the model may use (N−1) previous image(s)/frame(s) in order to the improve the prediction of frame number N. As described herein, the model may be trained over a large dataset of masks and input images in order to deal with any type of dropping areas (e.g., masks of different sizes, shapes, locations). For example, the output of the inpainting scheme may use the Generator output masked region (e.g., Output=Input·mask+Genₒᵤₜ. (1−mask)). Once the training process is complete, the output image may be very similar to the original input image regarding semantic features and structural similarity. While the loss information output from the discriminator 410 may be used to determine the training results of the GAN 400, the receiving device may use the image output (e.g., the fully reconstructed image and/or the mask portion of the image) to reconstruct the original image. Accordingly, the GAN 400 may be used, at least in part, to reconstruct the image from the masked and compressed image received from the XR device.

FIG. 5 shows an example of an image reconstruction model 500 that supports communication and sensing of physical level image compression in accordance with one or more aspects of the present disclosure. Aspects of the image reconstruction model 500 may implement and/or be implemented by the wireless communications system 100, the wireless communications system 200, the wireless communications system 300, and/or the GAN 400. Aspects of the image reconstruction model 500 may be implemented at or implemented by a UE 115 (e.g., an XR device), a UE associated the XR device, and/or a network entity 105, which may be examples of the corresponding devices described herein. The inpainting model 515 may be an example of a GAN 400 as described herein.

As described herein, an inpainting model 515 (e.g., a GAN) may receive a masked image 505, where the masked image 505 has at least a portion of image data removed. The inpainting model 515 may generate a reconstructed image 520 based on prior training frames. As described herein, sudden object insertions within an upcoming frame may not be properly reconstructed if the inserted object was not present in the prior frames. Accordingly, RF sensing data 510 may be input to the inpainting model to improve the prediction accuracy of the inpainting model 515. For example, the RF sensing data 510 may indicate the presence of new objects or the movement of objects that may otherwise cause blockages. For example, RF sensing data 510 may be used to train the inpainting model 515 to predict and detect blockages. In some examples, blockages may be predicted using RF sensing using an NN as described herein.

FIG. 6 shows an example of a wireless communications system 600 that supports communication and sensing of physical level image compression in accordance with one or more aspects of the present disclosure. The wireless communications system 600 may implement and/or be implemented by the wireless communications system 100, the wireless communications system 200, the wireless communications system 300, the GAN 400, and/or the image reconstruction model 500. For example, the wireless communications system 600 may include a UE 605, which may be an example of an XR UE 115 as described herein (e.g., a UE 205, an XR device 305, or a UE 605 as described herein). The wireless communications system 600 may include a wireless communication device 610-a and a wireless communication device 610-b, which may be examples of a UE 115, a network entity 105, a receiving device 210, a UE 310, or a network entity 315 as described herein.

The UE 605 may compress images by removing portions of the images in accordance with an inpainting scheme as described herein. The compressed images may be transmitted to the wireless communication device 610-a for processing to reduce the processing load at the UE 605. The object 615 may block a line of sight of a camera of the UE 605 to the object of interest 620 for inpainting. For example, the object 615 may be in the field of view of the camera of the UE 605 due to movement of the camera or due to movement of an object such as a user's hand in front of the camera. For example, the UE 605 may intend to remove a portion of the image that includes the object of interest 620 based on prior images, but the object 615 may move in front of the object of interest 620.

The UE 605, the wireless communication device 610-a, and/or the wireless communication device 610-b may perform RF sensing of RF signals 625 to detect the position of the object of interest 620 and/or the object 615 (e.g., the blockage). The RF sensing data may be used to determine whether to remove the portion of the image data that corresponds to the object of interest 620 and/or as an input to the inpainting scheme at the wireless communication device 610-a. For example, providing the RF sensing data as an input to the inpainting model may enable the inpainting model to accurately reconstruct images based on the sensed location of objects within the images for the portions of the images that were removed in accordance with the inpainting scheme.

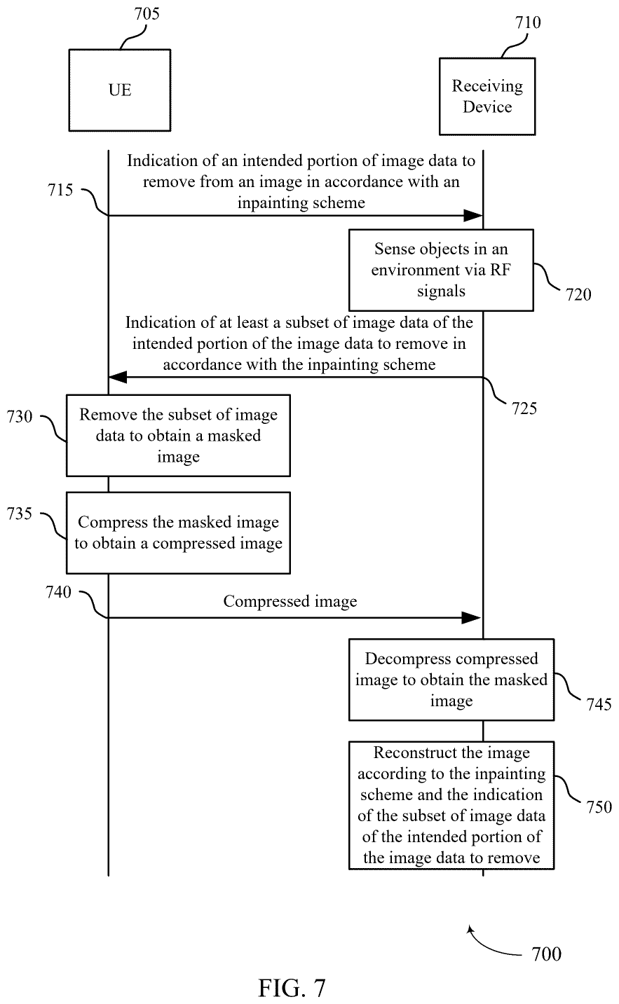

FIG. 7 shows an example of a process flow 700 that supports communication and sensing of physical level image compression in accordance with one or more aspects of the present disclosure. The process flow 700 may include a UE 705 and a wireless communication device 710. For example, the UE 705 may be an example of an XR UE 115 as described herein (e.g., a UE 205, an XR device 305, or a UE 605 as described herein). The wireless communication device 710 may be an example of a UE 115, a network entity 105, a receiving device 210, a UE 310, a network entity 315, or a wireless communication device 610 as described herein. In the following description of the process flow 700, the communications between the UE 705 and the wireless communication device 710 may be transmitted in a different order than the example order shown, or the operations performed by the UE 705 and the wireless communication device 710 may be performed in different orders or at different times. Some operations may also be omitted from the process flow 700, and other operations may be added to the process flow 700.

At 715, the UE 705 may transmit, to the wireless communication device 710, an indication of an intended portion of image data to remove from an image in accordance with an inpainting scheme. For example, the UE 705 may determine the intended portion of image data based on one or more masking parameters as described herein. For example, the intended portion of the image may correspond to an area of the image that has not changed in prior training frames. In some examples, as described herein, the UE 705 may perform RF sensing of the environment associated with the image to determine the intended portion of the image data to remove. For example, the UE 705 may perform RF sensing to determine whether any objects are in motion within a given area, and if not, the UE 705 may determine to remove that portion of the object.

At 720, the wireless communication device 710 may sense, via one or more RF signals, one or more objects in an environment associated with the image. In some examples, sensing via RF signals may involve transmitting the RF signals and receiving one or more reflected RF signals corresponding to the one or more RF signals that reflected off the one or more objects. In some examples, sensing via RF signals may involve receiving the one or more RF signals from the UE 705 or another wireless communication device, and the one or more RF signals may be reflected off the one or more objects. In some examples, the one or more RF signals may include FR2 RF signals, sub-terahertz RF signals, or a combination thereof. In some examples, the UE 705 may transmit the indication at 715 via an RF band, and the RF sensing at 720 may be associated with the RF band.

At 725, wireless communication device 710 may transmit, to the UE 705, an indication of at least a subset of image data of the intended portion of the image data to remove from the image in accordance with the inpainting scheme. The wireless communication device 710 may select the subset of image data based on the one or more objects in the environment sensed via the one or more RF signals. For example, the UE 705 may select to remove the subset based on the subset not including new objects (e.g., objects which were not present in training frames).

At 730, the UE 705 may remove the subset of image data to obtain a masked image. The masked image may have less data than the image. The masked image may be a remainder of the intended portion of image data other than the subset of image data. For example, when the UE 705 inputs the masked image to the compression scheme, the portion of the image that is masked may have null data.

At 735, the UE 705 may compress, according to a compression scheme, the masked image to obtain a compressed image. The compressed image may have less data than the masked image based on the compression. For example, the compression scheme may be H264, H265, or any other compression scheme that reduces the image size.

At 740, the UE 705 may transmit, to the wireless communication device 710, the compressed image. For example, the UE 705 may transmit the compressed image to the wireless communication device 710 via an uplink channel such as a PUSCH if the wireless communication device 710 is a network entity 105. As another example, the UE 705 may transmit the compressed image to the wireless communication device 710 via a sidelink channel such as a PSSCH if the wireless communication device 710 is a UE 115.

At 745, the wireless communication device 710 may decompress, according to the compression scheme, the compressed image to obtain a masked image. For example, the wireless communication device 710 may decompress the compressed image according to the same compression scheme that was used to compress the image at 735. For example, the wireless communication device 710 and the UE 705 may communicate parameters for the compression scheme.

At 750, the wireless communication device 710 may reconstruct, according to the inpainting scheme and the indication of the subset of image data of the intended portion of the image data to remove, the image from the masked image. In some examples, the image may be reconstructed from the masked image according to the inpainting scheme based on the sensing. For example, the wireless communication device 710 may train an AI model such as a GAN to reconstruct images with masked portions based on training frames as described herein. The wireless communication device 710 may use the trained AI model to reconstruct the image from the masked image based on knowledge of the portion of the image that was removed/masked.

In some examples, the UE 705 may sense, via one or more RF signals, one or more objects in the environment. In such examples, the intended portion of the image data may be selected based on the sensing the one or more objects. In some examples, the UE 705 may capture, via an image sensor of the UE 705 (e.g., a camera), the image, and one or more second objects may block the one or more objects with respect to the image sensor. In some examples, the UE 115 may capture, via the image sensor, one or more second images prior to capturing the image, the inpainting scheme may be based on the one or more second images, and the one or more second objects may be absent from the one or more second images. In some examples, the UE 705 may determine, based on the sensing, a change in position of the one or more objects at a time of the image with respect to the one or more second images, and the intended portion of the image data may be selected based on the change in position. In some examples, sensing by the UE 705 via RF signals may involve transmitting the RF signals and receiving one or more reflected RF signals corresponding to the one or more RF signals that reflected off the one or more objects. In some examples, sensing by the UE 705 via RF signals may involve receiving the one or more RF signals from the wireless communication device 710, and the one or more RF signals may be reflected off the one or more objects. In some examples, the one or more RF signals may include FR2 RF signals, sub-terahertz RF signals, or a combination thereof.

In some examples, the UE 705 may communicate, with the wireless communication device 710, one or more RF sensing parameters associated with the RF sensing of the environment. In some examples, the one or more RF sensing parameters may include one or more of an AoA, an AoD, an RSSI, a TDoA, or a combination thereof.

In some examples, the UE 705 may communicate, with the wireless communication device 710, capability signaling indicating a capability of the wireless communication device 710 to indicate subsets of intended portions of image data to remove based on RF sensing of the environment. In such examples, transmitting the indication of the intended portion of the image data at 715 may be based on the capability signaling.

In some examples, the UE 705 may remove the subset of image data from the image or from a field-of-view region of the image, the field-of-view region being based on one or more sensors associated with the UE. In some examples, removing the subset of image data at 730 may involve removing a masked portion of the image, removing a set of masked portions from each image in a corresponding set of images, removing a frame image from a video, or a combination thereof.

In some examples, the UE 705 may communicate, with the wireless communication device 710, to train the inpainting scheme (e.g., to train the model used for the inpainting scheme) to recover the image from the compressed image, and the inpainting scheme may be based on the training. For example, the UE 705 and the wireless communication device 710 may exchange AI model information, training frames, and feedback regarding the accuracy of the reconstructed training frames.

In some examples, the wireless communication device 710 may determine, based on the sensing at 720, that one or more second objects block the one or more objects with respect to a field of view of the UE 705. The subset of image data may be based on determining that the one or more second objects block the one or more objects with respect to the field of view of the UE 705. In some examples, the wireless communication device 710 may receive, from the UE 705, one or more second images prior to receiving the indication of the intended portion of the image data to remove at 715, the inpainting scheme may be based on the one or more second images, and the one or more second objects are absent from the one or more second images. In some examples, the wireless communication device 710 may determine, based on the sensing, a change in position of the one or more objects at a time subsequent to the one or more second images, and the subset of image data may be based on the change in position.

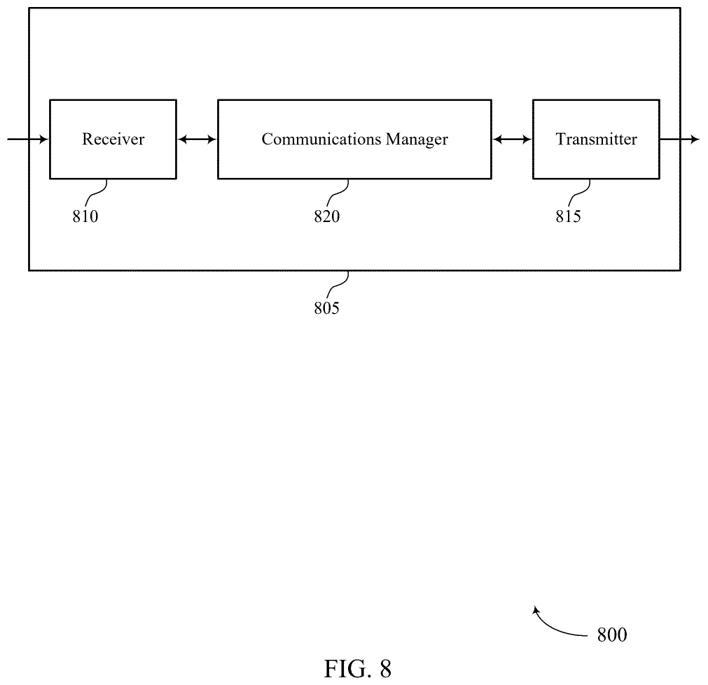

FIG. 8 shows a block diagram 800 of a device 805 that supports communication and sensing of physical level image compression in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to communication and sensing of physical level image compression). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to communication and sensing of physical level image compression). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of communication and sensing of physical level image compression as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a wireless communication device, an indication of an intended portion of image data to remove from an image in accordance with an inpainting scheme. The communications manager 820 is capable of, configured to, or operable to support a means for receiving, from the wireless communication device, an indication of at least a subset of image data of the intended portion of the image data to remove from the image in accordance with the inpainting scheme and RF sensing of an environment associated with the image. The communications manager 820 is capable of, configured to, or operable to support a means for removing the subset of image data to obtain a masked image, the masked image having less data than the image. The communications manager 820 is capable of, configured to, or operable to support a means for compressing, according to a compression scheme, the masked image to obtain a compressed image, the compressed image having less data than the masked image based on the compression. The communications manager 820 is capable of, configured to, or operable to support a means for transmitting, to the wireless communication device, the compressed image.

Additionally, or alternatively, the communications manager 820 may support wireless communications in accordance with examples as disclosed herein. For example, the communications manager 820 is capable of, configured to, or operable to support a means for receiving, from a UE, an indication of an intended portion of image data to remove from an image in accordance with an inpainting scheme. The communications manager 820 is capable of, configured to, or operable to support a means for sensing, via one or more RF signals, one or more objects in an environment associating with the image. The communications manager 820 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The communications manager 820 is capable of, configured to, or operable to support a means for receiving, from the UE, a compressed image. The communications manager 820 is capable of, configured to, or operable to support a means for decompressing, according to a compression scheme, the compressed image to obtain a masked image. The communications manager 820 is capable of, configured to, or operable to support a means for reconstructing, according to the inpainting scheme and the indication of the subset of image data of the intended portion of the image data to remove, the image from the masked image.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for enhanced image compression, reduced processing, reduced power consumption, and more efficient utilization of communication resources.

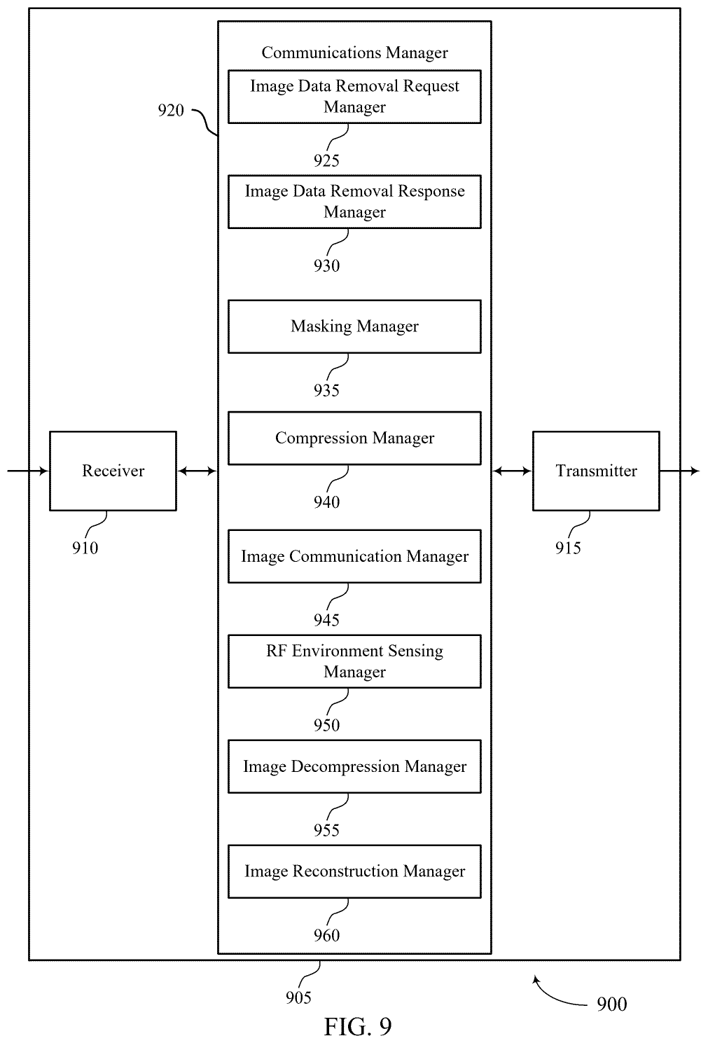

FIG. 9 shows a block diagram 900 of a device 905 that supports communication and sensing of physical level image compression in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to communication and sensing of physical level image compression). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to communication and sensing of physical level image compression). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of communication and sensing of physical level image compression as described herein. For example, the communications manager 920 may include an image data removal request manager 925, an image data removal response manager 930, a masking manager 935, a compression manager 940, an image communication manager 945, an RF environment sensing manager 950, an image decompression manager 955, an image reconstruction manager 960, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The image data removal request manager 925 is capable of, configured to, or operable to support a means for transmitting, to a wireless communication device, an indication of an intended portion of image data to remove from an image in accordance with an inpainting scheme. The image data removal response manager 930 is capable of, configured to, or operable to support a means for receiving, from the wireless communication device, an indication of at least a subset of image data of the intended portion of the image data to remove from the image in accordance with the inpainting scheme and RF sensing of an environment associated with the image. The masking manager 935 is capable of, configured to, or operable to support a means for removing the subset of image data to obtain a masked image, the masked image having less data than the image. The compression manager 940 is capable of, configured to, or operable to support a means for compressing, according to a compression scheme, the masked image to obtain a compressed image, the compressed image having less data than the masked image based on the compression. The image communication manager 945 is capable of, configured to, or operable to support a means for transmitting, to the wireless communication device, the compressed image.

Additionally, or alternatively, the communications manager 920 may support wireless communications in accordance with examples as disclosed herein. The image data removal request manager 925 is capable of, configured to, or operable to support a means for receiving, from a UE, an indication of an intended portion of image data to remove from an image in accordance with an inpainting scheme. The RF environment sensing manager 950 is capable of, configured to, or operable to support a means for sensing, via one or more RF signals, one or more objects in an environment associated with the image. The image data removal response manager 930 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The image communication manager 945 is capable of, configured to, or operable to support a means for receiving, from the UE, a compressed image. The image decompression manager 955 is capable of, configured to, or operable to support a means for decompressing, according to a compression scheme, the compressed image to obtain a masked image. The image reconstruction manager 960 is capable of, configured to, or operable to support a means for reconstructing, according to the inpainting scheme and the indication of the subset of image data of the intended portion of the image data to remove, the image from the masked image.

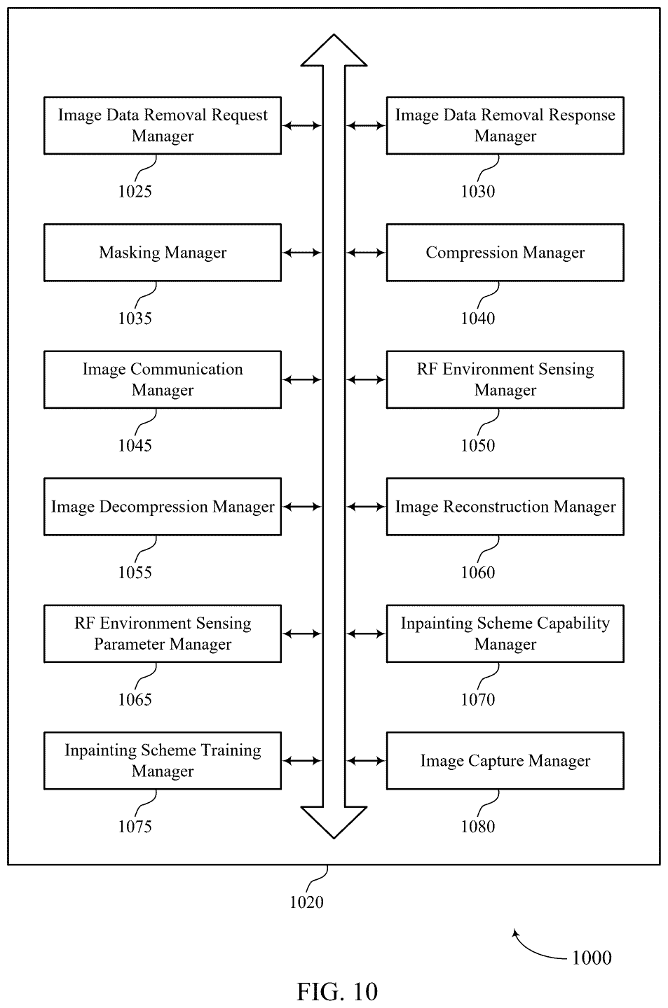

FIG. 10 shows a block diagram 1000 of a communications manager 1020 that supports communication and sensing of physical level image compression in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of communication and sensing of physical level image compression as described herein. For example, the communications manager 1020 may include an image data removal request manager 1025, an image data removal response manager 1030, a masking manager 1035, a compression manager 1040, an image communication manager 1045, an RF environment sensing manager 1050, an image decompression manager 1055, an image reconstruction manager 1060, an RF environment sensing parameter manager 1065, an inpainting scheme capability manager 1070, an inpainting scheme training manager 1075, an image capture manager 1080, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The image data removal request manager 1025 is capable of, configured to, or operable to support a means for transmitting, to a wireless communication device, an indication of an intended portion of image data to remove from an image in accordance with an inpainting scheme. The image data removal response manager 1030 is capable of, configured to, or operable to support a means for receiving, from the wireless communication device, an indication of at least a subset of image data of the intended portion of the image data to remove from the image in accordance with the inpainting scheme and RF sensing of an environment associated with the image. The masking manager 1035 is capable of, configured to, or operable to support a means for removing the subset of image data to obtain a masked image, the masked image having less data than the image. The compression manager 1040 is capable of, configured to, or operable to support a means for compressing, according to a compression scheme, the masked image to obtain a compressed image, the compressed image having less data than the masked image based on the compression. The image communication manager 1045 is capable of, configured to, or operable to support a means for transmitting, to the wireless communication device, the compressed image.

In some examples, the RF environment sensing manager 1050 is capable of, configured to, or operable to support a means for sensing, via one or more RF signals, one or more objects in the environment, where the intended portion of the image data is selected based on the sensing the one or more objects.

In some examples, the image capture manager 1080 is capable of, configured to, or operable to support a means for capturing, via an image sensor of the UE, the image, where one or more second objects block the one or more objects with respect to the image sensor.

In some examples, the image capture manager 1080 is capable of, configured to, or operable to support a means for capturing, via the image sensor, one or more second images prior to capture of the image, where the inpainting scheme is based on the one or more second images, and where the one or more second objects are absent from the one or more second images.

In some examples, the RF environment sensing manager 1050 is capable of, configured to, or operable to support a means for determining, based on the sensing, a change in position of the one or more objects at a time of the image with respect to the one or more second images, where the intended portion of the image data is selected based on the change in position.

In some examples, to support sensing, via the one or more RF signals, the RF environment sensing manager 1050 is capable of, configured to, or operable to support a means for transmitting the one or more RF signals. In some examples, to support sensing, via the one or more RF signals, the RF environment sensing manager 1050 is capable of, configured to, or operable to support a means for receiving one or more reflected RF signals corresponding to the one or more RF signals that reflected off the one or more objects.

In some examples, to support sensing, via the one or more RF signals, the RF environment sensing manager 1050 is capable of, configured to, or operable to support a means for receiving the one or more RF signals from the wireless communication device, where the one or more RF signals reflected off the one or more objects.

In some examples, the one or more RF signals include frequency range two RF signals, sub-terahertz RF signals, or a combination thereof.

In some examples, the RF environment sensing parameter manager 1065 is capable of, configured to, or operable to support a means for communicating, with the wireless communication device, one or more RF sensing parameters associated with the RF sensing of the environment.

In some examples, the one or more RF sensing parameters include one or more of an AoA, an AoD, an RSSI, a TDoA, or a combination thereof.

In some examples, the inpainting scheme capability manager 1070 is capable of, configured to, or operable to support a means for communicating, with the wireless communication device, capability signaling indicating a capability of the wireless communication device to indicate subsets of intended portions of image data to remove based on RF sensing of the environment, where transmitting the indication of the intended portion of the image data is based on the capability signaling.

In some examples, to support removing the subset of image data, the masking manager 1035 is capable of, configured to, or operable to support a means for removing the subset of image data from the image or from a field-of-view region of the image, the field-of-view region being based on one or more sensors associated with the UE.

In some examples, the subset of image data is removed in accordance with the inpainting scheme based on the RF sensing of the environment.

In some examples, to support removing the subset of image data, the masking manager 1035 is capable of, configured to, or operable to support a means for removing a masked portion of the image, removing a set of masked portions from each image in a corresponding set of images, removing a frame image from a video, or a combination thereof.

In some examples, the inpainting scheme training manager 1075 is capable of, configured to, or operable to support a means for communicating with the wireless communication device to train the inpainting scheme to recover the image from the compressed image, where the inpainting scheme is based on the training.

In some examples, to support transmitting the indication of the intended portion of the image data, the image data removal request manager 1025 is capable of, configured to, or operable to support a means for transmitting the indication via an RF band, where the RF sensing is associated with the RF band.

In some examples, the masked image includes a remainder of the intended portion of image data other than the subset of image data.

Additionally, or alternatively, the communications manager 1020 may support wireless communications in accordance with examples as disclosed herein. In some examples, the image data removal request manager 1025 is capable of, configured to, or operable to support a means for receiving, from a UE, an indication of an intended portion of image data to remove from an image in accordance with an inpainting scheme. The RF environment sensing manager 1050 is capable of, configured to, or operable to support a means for sensing, via one or more RF signals, one or more objects in an environment associated with the image. In some examples, the image data removal response manager 1030 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. In some examples, the image communication manager 1045 is capable of, configured to, or operable to support a means for receiving, from the UE, a compressed image. The image decompression manager 1055 is capable of, configured to, or operable to support a means for decompressing, according to a compression scheme, the compressed image to obtain a masked image. The image reconstruction manager 1060 is capable of, configured to, or operable to support a means for reconstructing, according to the inpainting scheme and the indication of the subset of image data of the intended portion of the image data to remove, the image from the masked image.

In some examples, the RF environment sensing manager 1050 is capable of, configured to, or operable to support a means for determining, based on the sensing, that one or more second objects block the one or more objects with respect to a field of view of the UE, where the subset of image data is based on determining that the one or more second objects block the one or more objects with respect to the field of view of the UE.

In some examples, the image communication manager 1045 is capable of, configured to, or operable to support a means for receiving, from the UE, one or more second images prior to receiving the indication of the intended portion of the image data to remove, where the inpainting scheme is based on the one or more second images, and where the one or more second objects are absent from the one or more second images.

In some examples, the RF environment sensing manager 1050 is capable of, configured to, or operable to support a means for determining, based on the sensing, a change in position of the one or more objects at a time subsequent to the one or more second images, where the subset of image data is based on the change in position.

In some examples, to support sensing, via the one or more RF signals, the RF environment sensing manager 1050 is capable of, configured to, or operable to support a means for transmitting the one or more RF signals. In some examples, to support sensing, via the one or more RF signals, the RF environment sensing manager 1050 is capable of, configured to, or operable to support a means for receiving one or more reflected RF signals corresponding to the one or more RF signals that reflected off the one or more objects.

In some examples, to support sensing, via the one or more RF signals, the RF environment sensing manager 1050 is capable of, configured to, or operable to support a means for receiving the one or more RF signals from the wireless communication device, where the one or more RF signals reflected off the one or more objects.

In some examples, the one or more RF signals include frequency range two RF signals, sub-terahertz RF signals, or a combination thereof.

In some examples, the RF environment sensing parameter manager 1065 is capable of, configured to, or operable to support a means for communicating, with the UE, one or more RF sensing parameters associated with RF sensing of the environment, where the sensing is based on the one or more RF sensing parameters.

In some examples, the one or more RF sensing parameters include one or more of an AoA, an AoD, an RSSI, a TDoA, or a combination thereof.

In some examples, the inpainting scheme capability manager 1070 is capable of, configured to, or operable to support a means for communicating, with the UE, capability signaling indicating a capability of the wireless communication device to indicate subsets of intended portions of image data to remove based on RF sensing of the environment, where reception of the indication of the intended portion of the image data is based on the capability signaling.

In some examples, the inpainting scheme training manager 1075 is capable of, configured to, or operable to support a means for communicating with the UE to train the inpainting scheme to recover the image from the compressed image, where the inpainting scheme is based on the training.

In some examples, the image data removal request manager 1025 is capable of, configured to, or operable to support a means for receiving the indication via an RF band, where the one or more RF signals are associated with the RF band.

In some examples, the image is reconstructed from the masked image according to the inpainting scheme based on the sensing.

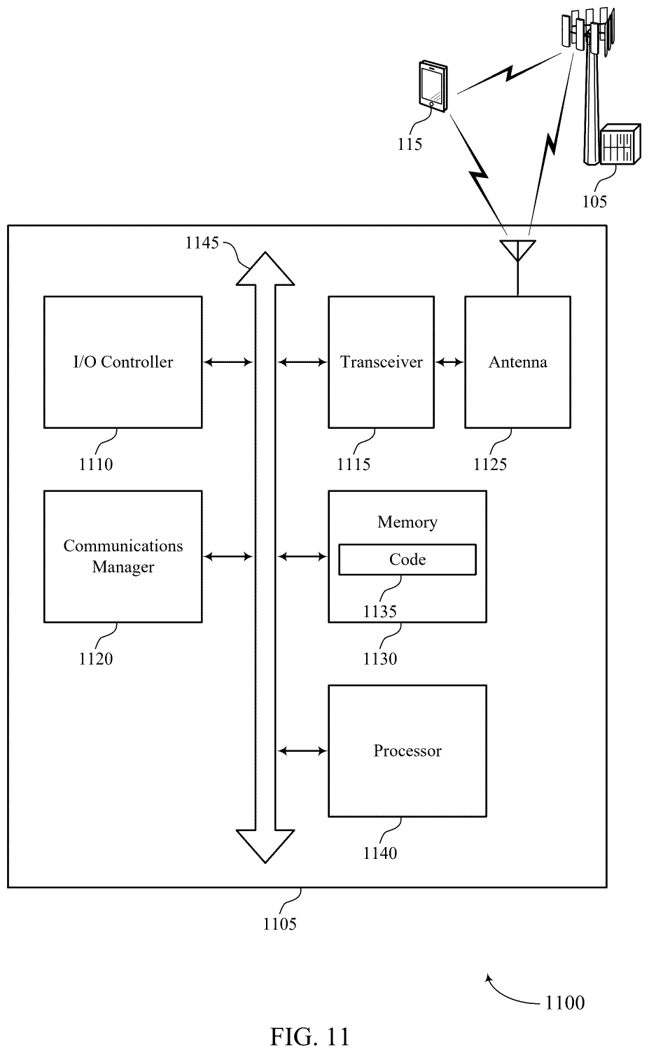

FIG. 11 shows a diagram of a system 1100 including a device 1105 that supports communication and sensing of physical level image compression in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting communication and sensing of physical level image compression). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting, to a wireless communication device, an indication of an intended portion of image data to remove from an image in accordance with an inpainting scheme. The communications manager 1120 is capable of, configured to, or operable to support a means for receiving, from the wireless communication device, an indication of at least a subset of image data of the intended portion of the image data to remove from the image in accordance with the inpainting scheme and RF sensing of an environment associated with the image. The communications manager 1120 is capable of, configured to, or operable to support a means for removing the subset of image data to obtain a masked image, the masked image having less data than the image. The communications manager 1120 is capable of, configured to, or operable to support a means for compressing, according to a compression scheme, the masked image to obtain a compressed image, the compressed image having less data than the masked image based on the compression. The communications manager 1120 is capable of, configured to, or operable to support a means for transmitting, to the wireless communication device, the compressed image.

Additionally, or alternatively, the communications manager 1120 may support wireless communications in accordance with examples as disclosed herein. For example, the communications manager 1120 is capable of, configured to, or operable to support a means for receiving, from a UE, an indication of an intended portion of image data to remove from an image in accordance with an inpainting scheme. The communications manager 1120 is capable of, configured to, or operable to support a means for sensing, via one or more RF signals, one or more objects in an environment associating with the image. The communications manager 1120 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The communications manager 1120 is capable of, configured to, or operable to support a means for receiving, from the UE, a compressed image. The communications manager 1120 is capable of, configured to, or operable to support a means for decompressing, according to a compression scheme, the compressed image to obtain a masked image. The communications manager 1120 is capable of, configured to, or operable to support a means for reconstructing, according to the inpainting scheme and the indication of the subset of image data of the intended portion of the image data to remove, the image from the masked image.

By including or configuring the communications manager 1120 in accordance with examples as described herein, the device 1105 may support techniques for enhanced image compression reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of communication and sensing of physical level image compression as described herein, or the at least one processor 1140 and the at least one memory 1130 may be otherwise configured to, individually or collectively, perform or support such operations.

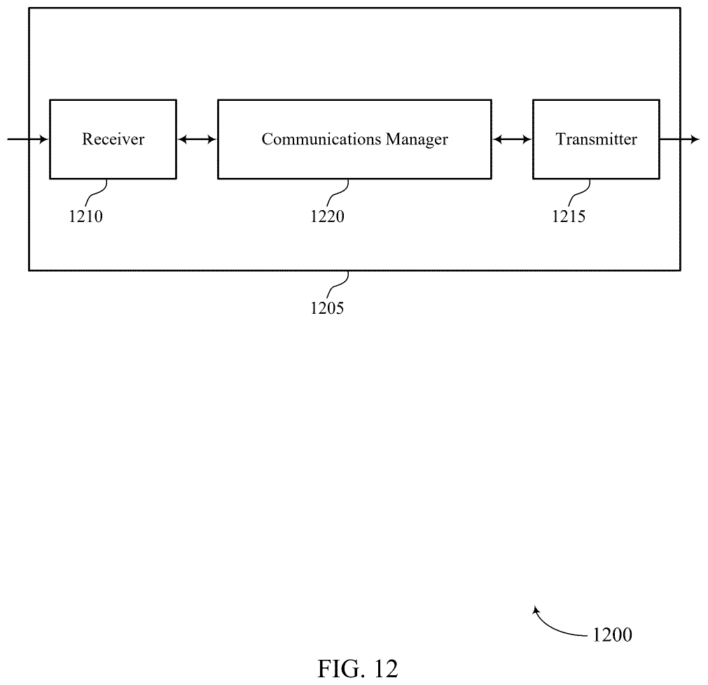

FIG. 12 shows a block diagram 1200 of a device 1205 that supports communication and sensing of physical level image compression in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of communication and sensing of physical level image compression as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving, from a UE, an indication of an intended portion of image data to remove from an image in accordance with an inpainting scheme. The communications manager 1220 is capable of, configured to, or operable to support a means for sensing, via one or more RF signals, one or more objects in an environment associating with the image. The communications manager 1220 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The communications manager 1220 is capable of, configured to, or operable to support a means for receiving, from the UE, a compressed image. The communications manager 1220 is capable of, configured to, or operable to support a means for decompressing, according to a compression scheme, the compressed image to obtain a masked image. The communications manager 1220 is capable of, configured to, or operable to support a means for reconstructing, according to the inpainting scheme and the indication of the subset of image data of the intended portion of the image data to remove, the image from the masked image.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for enhanced image compression, reduced processing, reduced power consumption, and more efficient utilization of communication resources.

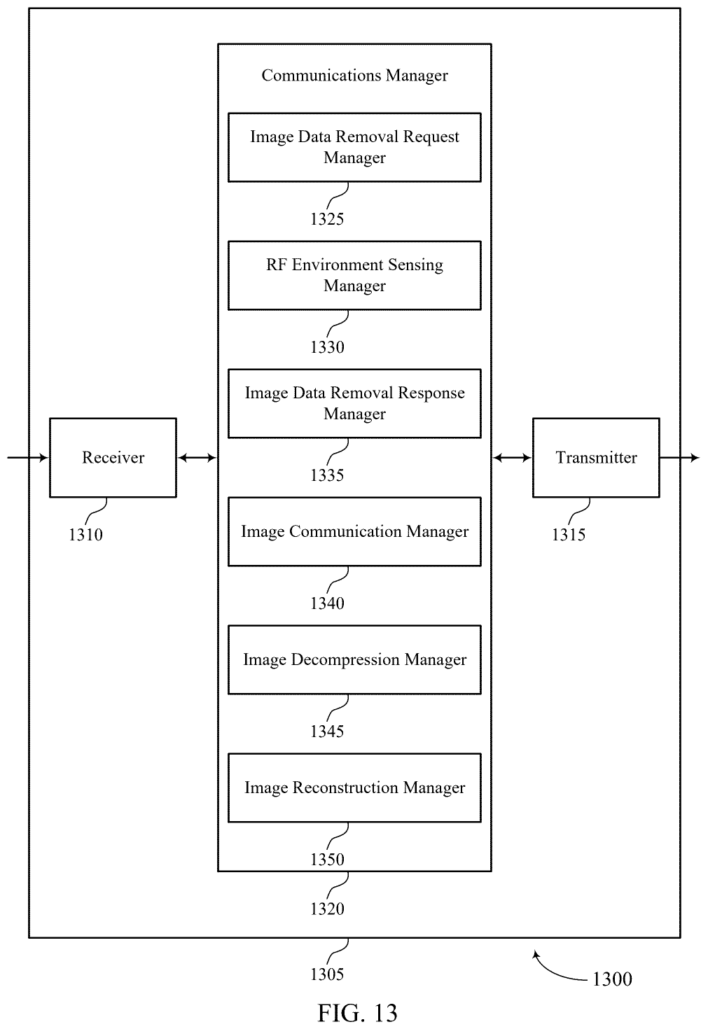

FIG. 13 shows a block diagram 1300 of a device 1305 that supports communication and sensing of physical level image compression in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of communication and sensing of physical level image compression as described herein. For example, the communications manager 1320 may include an image data removal request manager 1325, an RF environment sensing manager 1330, an image data removal response manager 1335, an image communication manager 1340, an image decompression manager 1345, an image reconstruction manager 1350, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The image data removal request manager 1325 is capable of, configured to, or operable to support a means for receiving, from a UE, an indication of an intended portion of image data to remove from an image in accordance with an inpainting scheme. The RF environment sensing manager 1330 is capable of, configured to, or operable to support a means for sensing, via one or more RF signals, one or more objects in an environment associated with the image. The image data removal response manager 1335 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The image communication manager 1340 is capable of, configured to, or operable to support a means for receiving, from the UE, a compressed image. The image decompression manager 1345 is capable of, configured to, or operable to support a means for decompressing, according to a compression scheme, the compressed image to obtain a masked image. The image reconstruction manager 1350 is capable of, configured to, or operable to support a means for reconstructing, according to the inpainting scheme and the indication of the subset of image data of the intended portion of the image data to remove, the image from the masked image.

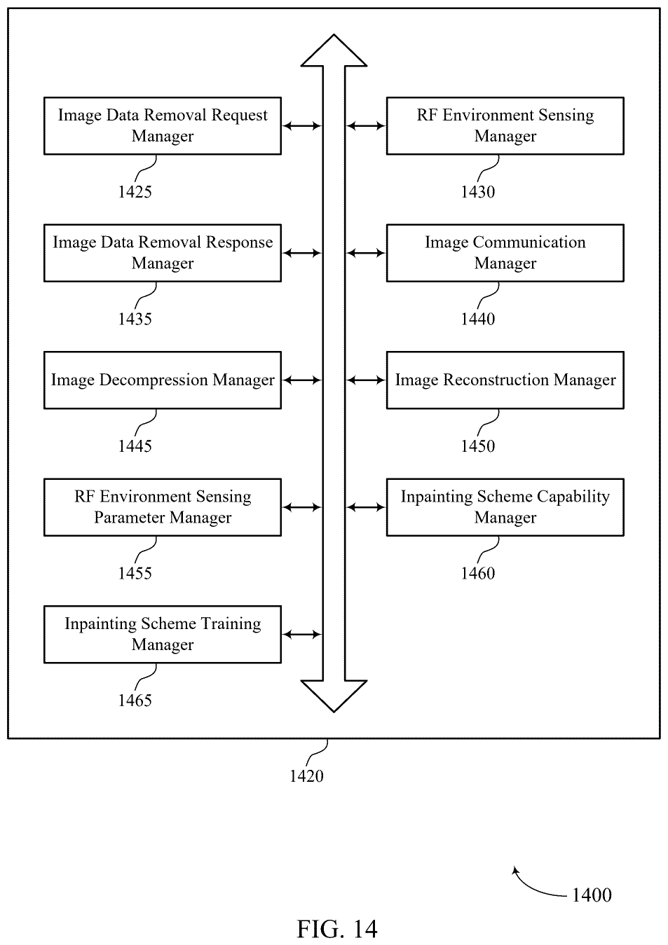

FIG. 14 shows a block diagram 1400 of a communications manager 1420 that supports communication and sensing of physical level image compression in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of communication and sensing of physical level image compression as described herein. For example, the communications manager 1420 may include an image data removal request manager 1425, an RF environment sensing manager 1430, an image data removal response manager 1435, an image communication manager 1440, an image decompression manager 1445, an image reconstruction manager 1450, an RF environment sensing parameter manager 1455, an inpainting scheme capability manager 1460, an inpainting scheme training manager 1465, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The image data removal request manager 1425 is capable of, configured to, or operable to support a means for receiving, from a UE, an indication of an intended portion of image data to remove from an image in accordance with an inpainting scheme. The RF environment sensing manager 1430 is capable of, configured to, or operable to support a means for sensing, via one or more RF signals, one or more objects in an environment associated with the image. The image data removal response manager 1435 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The image communication manager 1440 is capable of, configured to, or operable to support a means for receiving, from the UE, a compressed image. The image decompression manager 1445 is capable of, configured to, or operable to support a means for decompressing, according to a compression scheme, the compressed image to obtain a masked image. The image reconstruction manager 1450 is capable of, configured to, or operable to support a means for reconstructing, according to the inpainting scheme and the indication of the subset of image data of the intended portion of the image data to remove, the image from the masked image.

In some examples, the RF environment sensing manager 1430 is capable of, configured to, or operable to support a means for determining, based on the sensing, that one or more second objects block the one or more objects with respect to a field of view of the UE, where the subset of image data is based on determining that the one or more second objects block the one or more objects with respect to the field of view of the UE.

In some examples, the image communication manager 1440 is capable of, configured to, or operable to support a means for receiving, from the UE, one or more second images prior to receiving the indication of the intended portion of the image data to remove, where the inpainting scheme is based on the one or more second images, and where the one or more second objects are absent from the one or more second images.

In some examples, the RF environment sensing manager 1430 is capable of, configured to, or operable to support a means for determining, based on the sensing, a change in position of the one or more objects at a time subsequent to the one or more second images, where the subset of image data is based on the change in position.

In some examples, to support sensing, via the one or more RF signals, the RF environment sensing manager 1430 is capable of, configured to, or operable to support a means for transmitting the one or more RF signals. In some examples, to support sensing, via the one or more RF signals, the RF environment sensing manager 1430 is capable of, configured to, or operable to support a means for receiving one or more reflected RF signals corresponding to the one or more RF signals that reflected off the one or more objects.

In some examples, to support sensing, via the one or more RF signals, the RF environment sensing manager 1430 is capable of, configured to, or operable to support a means for receiving the one or more RF signals from the UE, where the one or more RF signals reflected off the one or more objects.

In some examples, the one or more RF signals include frequency range two RF signals, sub-terahertz RF signals, or a combination thereof.

In some examples, the RF environment sensing parameter manager 1455 is capable of, configured to, or operable to support a means for communicating, with the UE, one or more RF sensing parameters associated with RF sensing of the environment, where the sensing is based on the one or more RF sensing parameters.

In some examples, the one or more RF sensing parameters include one or more of an AoA, an AoD, an RSSI, a TDoA, or a combination thereof.

In some examples, the inpainting scheme capability manager 1460 is capable of, configured to, or operable to support a means for communicating, with the UE, capability signaling indicating a capability of the wireless communication device to indicate subsets of intended portions of image data to remove based on RF sensing of the environment, where reception of the indication of the intended portion of the image data is based on the capability signaling.

In some examples, the inpainting scheme training manager 1465 is capable of, configured to, or operable to support a means for communicating with the UE to train the inpainting scheme to recover the image from the compressed image, where the inpainting scheme is based on the training.

In some examples, the image data removal request manager 1425 is capable of, configured to, or operable to support a means for receiving the indication via an RF band, where the one or more RF signals are associated with the RF band.

In some examples, the image is reconstructed from the masked image according to the inpainting scheme based on the sensing.

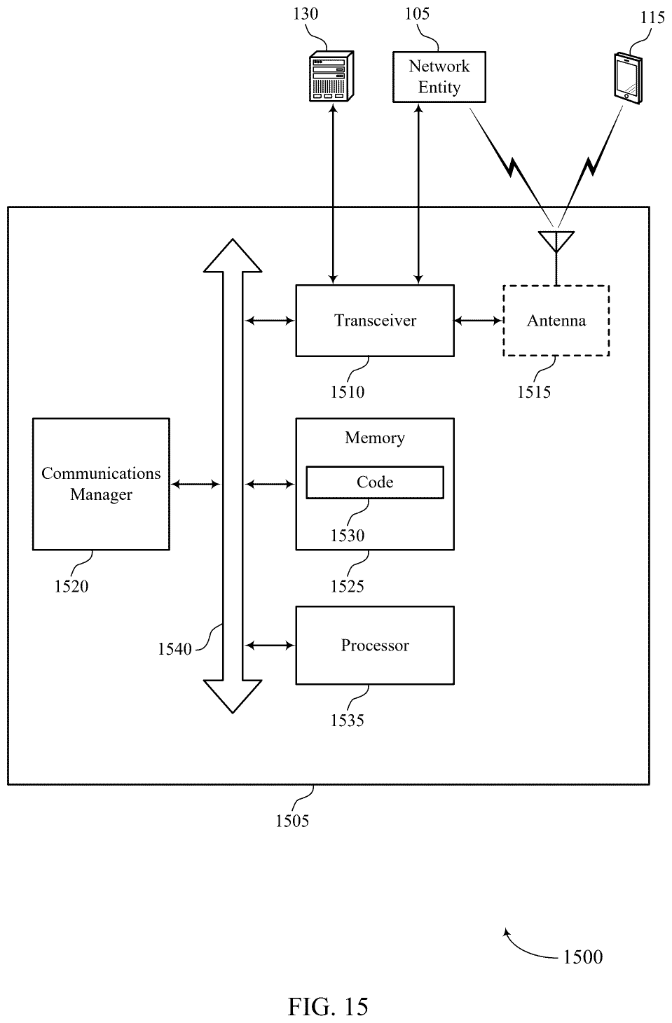

FIG. 15 shows a diagram of a system 1500 including a device 1505 that supports communication and sensing of physical level image compression in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting communication and sensing of physical level image compression). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for receiving, from a UE, an indication of an intended portion of image data to remove from an image in accordance with an inpainting scheme. The communications manager 1520 is capable of, configured to, or operable to support a means for sensing, via one or more RF signals, one or more objects in an environment associating with the image. The communications manager 1520 is capable of, configured to, or operable to support a means for transmitting, to the UE, an indication of at least a subset of image data of the intended portion of the image data to remove from the image in accordance with the inpainting scheme and based on the one or more objects in the environment sensed via the one or more RF signals. The communications manager 1520 is capable of, configured to, or operable to support a means for receiving, from the UE, a compressed image. The communications manager 1520 is capable of, configured to, or operable to support a means for decompressing, according to a compression scheme, the compressed image to obtain a masked image. The communications manager 1520 is capable of, configured to, or operable to support a means for reconstructing, according to the inpainting scheme and the indication of the subset of image data of the intended portion of the image data to remove, the image from the masked image.

By including or configuring the communications manager 1520 in accordance with examples as described herein, the device 1505 may support techniques for enhanced image compression reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of communication and sensing of physical level image compression as described herein, or the at least one processor 1535 and the at least one memory 1525 may be otherwise configured to, individually or collectively, perform or support such operations.

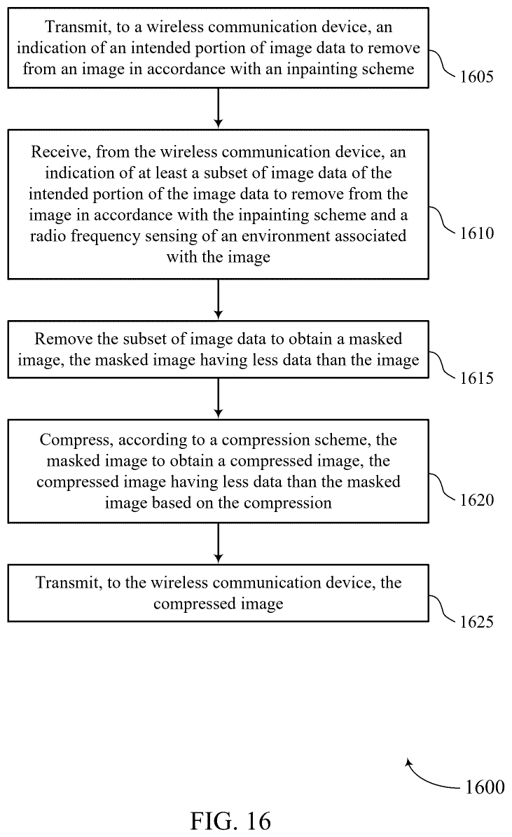

FIG. 16 shows a flowchart illustrating a method 1600 that supports communication and sensing of physical level image compression in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting, to a wireless communication device, an indication of an intended portion of image data to remove from an image in accordance with an inpainting scheme. The operations of 1605 may be performed in accordance with examples as disclosed herein, such as transmission at 240 as described with reference to FIG. 2. In some examples, aspects of the operations of 1605 may be performed by an image data removal request manager 1025 as described with reference to FIG. 10.

At 1610, the method may include receiving, from the wireless communication device, an indication of at least a subset of image data of the intended portion of the image data to remove from the image in accordance with the inpainting scheme and RF sensing of an environment associated with the image, such as reception of the transmission at 245 as described with reference to FIG. 2. The operations of 1610 may be performed in accordance with examples as disclosed herein. In some examples, aspects of the operations of 1610 may be performed by an image data removal response manager 1030 as described with reference to FIG. 10.

At 1615, the method may include removing the subset of image data to obtain a masked image, the masked image having less data than the image. The operations of 1615 may be performed in accordance with examples as disclosed herein, such as removing part of the image 225 to obtain a masked image as described with reference to FIG. 2. In some examples, aspects of the operations of 1615 may be performed by a masking manager 1035 as described with reference to FIG. 10.

At 1620, the method may include compressing, according to a compression scheme, the masked image to obtain a compressed image, the compressed image having less data than the masked image based on the compression. The operations of 1620 may be performed in accordance with examples as disclosed herein, such as compressing the masked image prior to the transmission at 220 as described with reference to FIG. 2. In some examples, aspects of the operations of 1620 may be performed by a compression manager 1040 as described with reference to FIG. 10.

At 1625, the method may include transmitting, to the wireless communication device, the compressed image. The operations of 1625 may be performed in accordance with examples as disclosed herein such as transmission at 220 of the compressed image as described with reference to FIG. 2. In some examples, aspects of the operations of 1625 may be performed by an image communication manager 1045 as described with reference to FIG. 10.

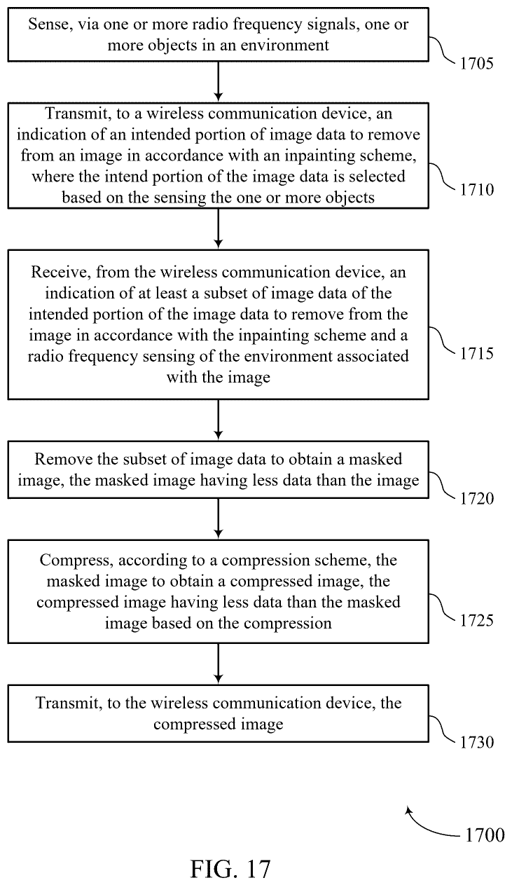

FIG. 17 shows a flowchart illustrating a method 1700 that supports communication and sensing of physical level image compression in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include sensing, via one or more RF signals, one or more objects in an environment. The operations of 1705 may be performed in accordance with examples as disclosed herein, such as detection of one or more objects 255 or of an object 615 as described with reference to FIGS. 2 and 6. In some examples, aspects of the operations of 1705 may be performed by an RF environment sensing manager 1050 as described with reference to FIG. 10.

At 1710, the method may include transmitting, to a wireless communication device, an indication of an intended portion of image data to remove from an image in accordance with an inpainting scheme, where the intended portion of the image data is selected based on the sensing the one or more objects. The operations of 1710 may be performed in accordance with examples as disclosed herein, such as the transmission at 240 as described with reference to FIG. 2. In some examples, aspects of the operations of 1710 may be performed by an image data removal request manager 1025 as described with reference to FIG. 10.

At 1715, the method may include receiving, from the wireless communication device, an indication of at least a subset of image data of the intended portion of the image data to remove from the image in accordance with the inpainting scheme and RF sensing of the environment associated with the image, such as reception of the transmission at 245 as described with reference to FIG. 2. The operations of 1715 may be performed in accordance with examples as disclosed herein. In some examples, aspects of the operations of 1715 may be performed by an image data removal response manager 1030 as described with reference to FIG. 10.

At 1720, the method may include removing the subset of image data to obtain a masked image, the masked image having less data than the image. The operations of 1720 may be performed in accordance with examples as disclosed herein such as removing part of the image 225 to obtain a masked image as described with reference to FIG. 2. In some examples, aspects of the operations of 1720 may be performed by a masking manager 1035 as described with reference to FIG. 10.

At 1725, the method may include compressing, according to a compression scheme, the masked image to obtain a compressed image, the compressed image having less data than the masked image based on the compression. The operations of 1725 may be performed in accordance with examples as disclosed herein, such as compressing the masked image prior to the transmission at 220 as described with reference to FIG. 2. In some examples, aspects of the operations of 1725 may be performed by a compression manager 1040 as described with reference to FIG. 10.

At 1730, the method may include transmitting, to the wireless communication device, the compressed image. The operations of 1730 may be performed in accordance with examples as disclosed herein, such as transmission at 220 of the compressed image as described with reference to FIG. 2. In some examples, aspects of the operations of 1730 may be performed by an image communication manager 1045 as described with reference to FIG. 10.

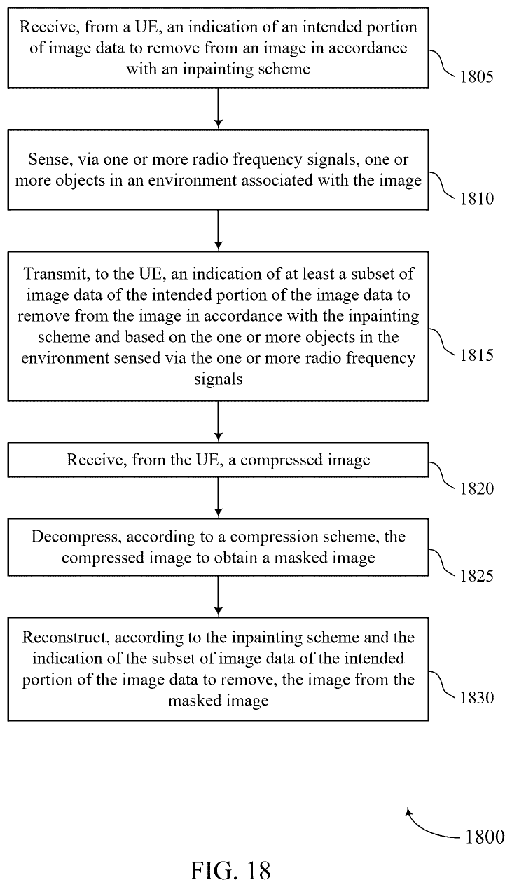

FIG. 18 shows a flowchart illustrating a method 1800 that supports communication and sensing of physical level image compression in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 11 or a network entity as described with reference to FIGS. 1 through 7 and 12 through 15. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving, from a UE, an indication of an intended portion of image data to remove from an image in accordance with an inpainting scheme. The operations of 1805 may be performed in accordance with examples as disclosed herein, such as reception of the transmission at 240 as described with reference to FIG. 2. In some examples, aspects of the operations of 1805 may be performed by an image data removal request manager 1025 or an image data removal request manager 1425 as described with reference to FIGS. 10 and 14.

At 1810, the method may include sensing, via one or more RF signals, one or more objects in an environment associated with the image. The operations of 1810 may be performed in accordance with examples as disclosed herein, such as detection of one or more objects 255 or of an object 615 as described with reference to FIGS. 2 and 6. In some examples, aspects of the operations of 1810 may be performed by an RF environment sensing manager 1050 or an RF environment sensing manager 1430 as described with reference to FIGS. 10 and 14.

At 1815, the method may include transmitting, to the UE, an indication of at least a subset of image data of the intended portion of the image data to remove from the image in accordance with the inpainting scheme and based on the one or more objects in the environment sensed via the one or more RF signals. The operations of 1815 may be performed in accordance with examples as disclosed herein, such as the transmission at 245 as described with reference to FIG. 2. In some examples, aspects of the operations of 1815 may be performed by an image data removal response manager 1030 or an image data removal response manager 1435 as described with reference to FIGS. 10 and 14.

At 1820, the method may include receiving, from the UE, a compressed image. The operations of 1820 may be performed in accordance with examples as disclosed herein, such as reception at 220 of the compressed image as described with reference to FIG. 2. In some examples, aspects of the operations of 1820 may be performed by an image communication manager 1045 or an image communication manager 1440 as described with reference to FIGS. 10 and 14.

At 1825, the method may include decompressing, according to a compression scheme, the compressed image to obtain a masked image. The operations of 1825 may be performed in accordance with examples as disclosed herein, such as decompressing the compressed image received at 220 as described with reference to FIG. 2. In some examples, aspects of the operations of 1825 may be performed by an image decompression manager 1055 or an image decompression manager 1445 as described with reference to FIGS. 10 and 14.

At 1830, the method may include reconstructing, according to the inpainting scheme and the indication of the subset of image data of the intended portion of the image data to remove, the image from the masked image. The operations of 1830 may be performed in accordance with examples as disclosed herein, such as reconstructing the image 225 from a masked image using a GAN as described with reference to FIGS. 2, 3, and 4. In some examples, aspects of the operations of 1830 may be performed by an image reconstruction manager 1060 or an image reconstruction manager 1450 as described with reference to FIGS. 10 and 14.

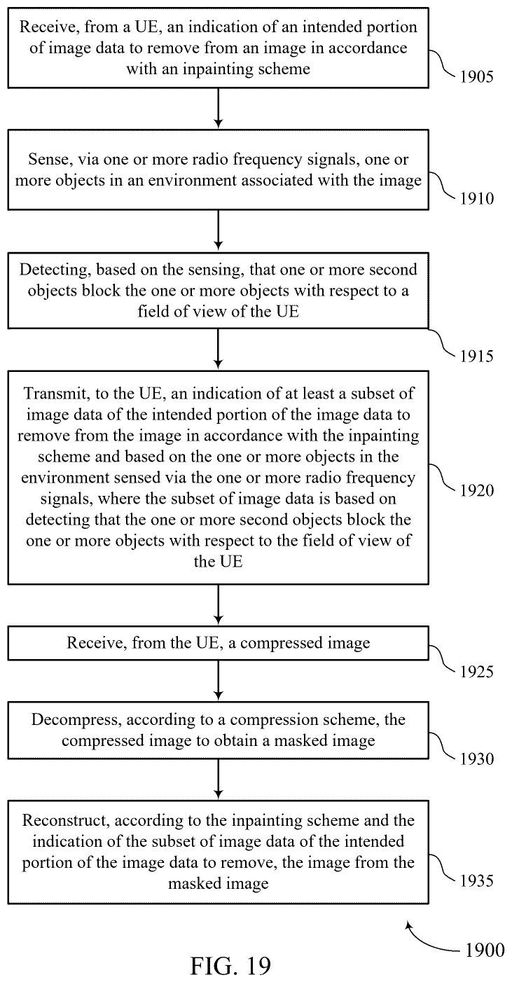

FIG. 19 shows a flowchart illustrating a method 1900 that supports communication and sensing of physical level image compression in accordance with one or more aspects of the present disclosure. The operations of the method 1900 may be implemented by a UE or a network entity or its components as described herein. For example, the operations of the method 1900 may be performed by a UE 115 as described with reference to FIGS. 1 through 11 or a network entity as described with reference to FIGS. 1 through 7 and 12 through 15. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include receiving, from a UE, an indication of an intended portion of image data to remove from an image in accordance with an inpainting scheme. The operations of 1905 may be performed in accordance with examples as disclosed herein, such as reception of the transmission at 240 as described with reference to FIG. 2. In some examples, aspects of the operations of 1905 may be performed by an image data removal request manager 1025 or an image data removal request manager 1425 as described with reference to FIGS. 10 and 14.

At 1910, the method may include sensing, via one or more RF signals, one or more objects in an environment associated with the image. The operations of 1910 may be performed in accordance with examples as disclosed herein, such as detection of one or more objects 255 or of an object 615 as described with reference to FIGS. 2 and 6. In some examples, aspects of the operations of 1910 may be performed by an RF environment sensing manager 1050 or an RF environment sensing manager 1430 as described with reference to FIGS. 10 and 14.

At 1915, the method may include determining, based on the sensing, that one or more second objects block the one or more objects with respect to a field of view of the UE. The operations of 1915 may be performed in accordance with examples as disclosed herein, such as detection an object 615 that blocks the object of interest 620 as described with reference to FIG. 6. In some examples, aspects of the operations of 1915 may be performed by an RF environment sensing manager 1050 or an RF environment sensing manager 1430 as described with reference to FIGS. 10 and 14.

At 1920, the method may include transmitting, to the UE, an indication of at least a subset of image data of the intended portion of the image data to remove from the image in accordance with the inpainting scheme and based on the one or more objects in the environment sensed via the one or more RF signals, where the subset of image data is based on determining that the one or more second objects block the one or more objects with respect to the field of view of the UE. The operations of 1920 may be performed in accordance with examples as disclosed herein such as the transmission at 245 as described with reference to FIG. 2. In some examples, aspects of the operations of 1920 may be performed by an image data removal response manager 1030 or an image data removal response manager 1435 as described with reference to FIGS. 10 and 14.

At 1925, the method may include receiving, from the UE, a compressed image. The operations of 1925 may be performed in accordance with examples as disclosed herein, such as reception at 220 of the compressed image as described with reference to FIG. 2. In some examples, aspects of the operations of 1925 may be performed by an image communication manager 1045 or an image communication manager 1440 as described with reference to FIGS. 10 and 14.

At 1930, the method may include decompressing, according to a compression scheme, the compressed image to obtain a masked image. The operations of 1930 may be performed in accordance with examples as disclosed herein, such as decompressing the compressed image received at 220 as described with reference to FIG. 2. In some examples, aspects of the operations of 1930 may be performed by an image decompression manager 1055 or an image decompression manager 1445 as described with reference to FIGS. 10 and 14.

At 1935, the method may include reconstructing, according to the inpainting scheme and the indication of the subset of image data of the intended portion of the image data to remove, the image from the masked image. The operations of 1935 may be performed in accordance with examples as disclosed herein, such as reconstructing the image 225 from a masked image using a GAN as described with reference to FIGS. 2, 3, and 4. In some examples, aspects of the operations of 1935 may be performed by an image reconstruction manager 1060 or an image reconstruction manager 1450 as described with reference to FIGS. 10 and 14.

The following provides an overview of aspects of the present disclosure:

Aspect 1: A method for wireless communications at a UE, comprising: transmitting, to a wireless communication device, an indication of an intended portion of image data to remove from an image in accordance with an inpainting scheme; receiving, from the wireless communication device, an indication of at least a subset of image data of the intended portion of the image data to remove from the image in accordance with the inpainting scheme and an RF sensing of an environment associated with the image; removing the subset of image data to obtain a masked image, the masked image having less data than the image; compressing, according to a compression scheme, the masked image to obtain a compressed image, the compressed image having less data than the masked image based at least in part on the compression; and transmitting, to the wireless communication device, the compressed image.

Aspect 2: The method of aspect 1, further comprising: sensing, via one or more RF signals, one or more objects in the environment, wherein the intended portion of the image data is selected based at least in part on the sensing the one or more objects.

Aspect 3: The method of aspect 2, further comprising: capturing, via an image sensor of the UE, the image, wherein one or more second objects block the one or more objects with respect to the image sensor.

Aspect 4: The method of aspect 3, further comprising: capturing, via the image sensor, one or more second images prior to capture of the image, wherein the inpainting scheme is based at least in part on the one or more second images, and wherein the one or more second objects are absent from the one or more second images.

Aspect 5: The method of aspect 4, further comprising: determining, based at least in part on the sensing, a change in position of the one or more objects at a time of the image with respect to the one or more second images, wherein the intended portion of the image data is selected based at least in part on the change in position.

Aspect 6: The method of any of aspects 2 through 5, wherein sensing, via the one or more RF signals comprises: transmitting the one or more RF signals; and receiving one or more reflected RF signals corresponding to the one or more RF signals that reflected off the one or more objects.

Aspect 7: The method of any of aspects 2 through 6, wherein sensing, via the one or more RF signals comprises: receiving the one or more RF signals from the wireless communication device, wherein the one or more RF signals reflected off the one or more objects.

Aspect 8: The method of any of aspects 2 through 7, wherein the one or more RF signals comprise frequency range two RF signals, sub-terahertz RF signals, or a combination thereof.

Aspect 9: The method of any of aspects 1 through 8, further comprising: communicating, with the wireless communication device, one or more RF sensing parameters associated with the RF sensing of the environment.

Aspect 10: The method of aspect 9, wherein the one or more RF sensing parameters comprise one or more of an AoA, an AoD, an RSSI, a TDoA, or a combination thereof.

Aspect 11: The method of any of aspects 1 through 10, further comprising: communicating, with the wireless communication device, capability signaling indicating a capability of the wireless communication device to indicate subsets of intended portions of image data to remove based at least in part on RF sensing of the environment, wherein transmitting the indication of the intended portion of the image data is based at least in part on the capability signaling.

Aspect 12: The method of any of aspects 1 through 11, wherein removing the subset of image data comprises: removing the subset of image data from the image or from a field-of-view region of the image, the field-of-view region being based at least in part on one or more sensors associated with the UE.

Aspect 13: The method of aspect 12, wherein the subset of image data is removed in accordance with the inpainting scheme based at least in part on the RF sensing of the environment.

Aspect 14: The method of any of aspects 1 through 13, wherein removing the subset of image data comprises at least one of: removing a masked portion of the image, removing a set of masked portions from each image in a corresponding set of images, removing a frame image from a video, or a combination thereof.

Aspect 15: The method of any of aspects 1 through 14, further comprising: communicating with the wireless communication device to train the inpainting scheme to recover the image from the compressed image, wherein the inpainting scheme is based at least in part on the training.

Aspect 16: The method of any of aspects 1 through 15, wherein transmitting the indication of the intended portion of the image data comprises: transmitting the indication via an RF band, wherein the RF sensing is associated with the RF band.

Aspect 17: The method of any of aspects 1 through 16, wherein the masked image comprises a remainder of the intended portion of image data other than the subset of image data.

Aspect 18: A method for wireless communications at a wireless communication device, comprising: receiving, from a UE, an indication of an intended portion of image data to remove from an image in accordance with an inpainting scheme; sensing, via one or more RF signals, one or more objects in an environment associated with the image; transmitting, to the UE, an indication of at least a subset of image data of the intended portion of the image data to remove from the image in accordance with the inpainting scheme and based at least in part on the one or more objects in the environment sensed via the one or more RF signals; receiving, from the UE, a compressed image; decompressing, according to a compression scheme, the compressed image to obtain a masked image; and reconstructing, according to the inpainting scheme and the indication of the subset of image data of the intended portion of the image data to remove, the image from the masked image.

Aspect 19: The method of aspect 18, further comprising: determining, based at least in part on the sensing, that one or more second objects block the one or more objects with respect to a field of view of the UE, wherein the subset of image data is based at least in part on determining that the one or more second objects block the one or more objects with respect to the field of view of the UE.

Aspect 20: The method of aspect 19, further comprising: receiving, from the UE, one or more second images prior to receiving the indication of the intended portion of the image data to remove, wherein the inpainting scheme is based at least in part on the one or more second images, and wherein the one or more second objects are absent from the one or more second images.

Aspect 21: The method of aspect 20, further comprising: determining, based at least in part on the sensing, a change in position of the one or more objects at a time subsequent to the one or more second images, wherein the subset of image data is based at least in part on the change in position.

Aspect 22: The method of any of aspects 18 through 21, wherein sensing, via the one or more RF signals comprises: transmitting the one or more RF signals; and receiving one or more reflected RF signals corresponding to the one or more RF signals that reflected off the one or more objects.

Aspect 23: The method of any of aspects 18 through 22, wherein sensing, via the one or more RF signals comprises: receiving the one or more RF signals from the UE, wherein the one or more RF signals reflected off the one or more objects.

Aspect 24: The method of any of aspects 18 through 23, wherein the one or more RF signals comprise frequency range two RF signals, sub-terahertz RF signals, or a combination thereof.

Aspect 25: The method of any of aspects 18 through 24, further comprising: communicating, with the UE, one or more RF sensing parameters associated with RF sensing of the environment, wherein the sensing is based at least in part on the one or more RF sensing parameters.

Aspect 26: The method of aspect 25, wherein the one or more RF sensing parameters comprise one or more of an AoA, an AoD, an RSSI, a TDoA, or a combination thereof.

Aspect 27: The method of any of aspects 18 through 26, further comprising: communicating, with the UE, capability signaling indicating a capability of the wireless communication device to indicate subsets of intended portions of image data to remove based at least in part on RF sensing of the environment, wherein reception of the indication of the intended portion of the image data is based at least in part on the capability signaling.

Aspect 28: The method of any of aspects 18 through 27, further comprising: communicating with the UE to train the inpainting scheme to recover the image from the compressed image, wherein the inpainting scheme is based at least in part on the training.

Aspect 29: The method of any of aspects 18 through 28, further comprising: receiving the indication via an RF band, wherein the one or more RF signals are associated with the RF band.

Aspect 30: The method of any of aspects 18 through 29, wherein the image is reconstructed from the masked image according to the inpainting scheme based at least in part on the sensing.

Aspect 31: An apparatus for wireless communication at a UE, comprising: one or more processors; one or more memories coupled with the one or more processors; and one or more processor-readable instructions stored in the one or more memories and executable by the one or more processors individually or collectively to cause the apparatus to perform a method of any of aspects 1 through 17.

Aspect 32: A UE for wireless communications, comprising at least one means for performing a method of any of aspects 1 through 17.

Aspect 33: A non-transitory computer-readable medium storing code for wireless communications, the code comprising instructions executable by one or more processors to perform a method of any of aspects 1 through 17.

Aspect 34: A apparatus for wireless communication at a wireless communication device, comprising: one or more processors; one or more memories coupled with the one or more processors; and one or more processor-readable instructions stored in the one or more memories and executable by the one or more processors individually or collectively to cause the apparatus to perform a method of any of aspects 18 through 30.

Aspect 35: A wireless communication device for wireless communications, comprising at least one means for performing a method of any of aspects 18 through 30.

Aspect 36: A non-transitory computer-readable medium storing code for wireless communications, the code comprising instructions executable by one or more processors to perform a method of any of aspects 18 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more processors;
one or more memories coupled with the one or more processors; and
one or more processor-readable instructions stored in the one or more memories and executable by the one or more processors individually or collectively to cause the apparatus to:
transmit, to a wireless communication device, an indication of an intended portion of image data to remove from an image in accordance with an inpainting scheme;
receive, from the wireless communication device, an indication of at least a subset of image data of the intended portion of the image data to remove from the image in accordance with the inpainting scheme and a radio frequency sensing of an environment associated with the image;
remove the subset of image data to obtain a masked image, the masked image having less data than the image;
compress, according to a compression scheme, the masked image to obtain a compressed image, the compressed image having less data than the masked image based at least in part on the compression; and
transmit, to the wireless communication device, the compressed image.

2. The apparatus of claim 1, wherein the one or more processor-readable instructions are further executable by the one or more processors individually or collectively to cause the apparatus to:
sense, via one or more radio frequency signals, one or more objects in the environment, wherein the intended portion of the image data is selected based at least in part on the sensing the one or more objects.

3. The apparatus of claim 2, wherein the one or more processor-readable instructions are further executable by the one or more processors individually or collectively to cause the apparatus to:
capture, via an image sensor of the UE, the image, wherein one or more second objects block the one or more objects with respect to the image sensor.

4. The apparatus of claim 3, wherein the one or more processor-readable instructions are further executable by the one or more processors individually or collectively to cause the apparatus to:
capture, via the image sensor, one or more second images prior to capture of the image, wherein the inpainting scheme is based at least in part on the one or more second images, and wherein the one or more second objects are absent from the one or more second images.

5. The apparatus of claim 4, wherein the one or more processor-readable instructions are further executable by the one or more processors individually or collectively to cause the apparatus to:
determine, based at least in part on the sensing, a change in position of the one or more objects at a time of the image with respect to the one or more second images, wherein the intended portion of the image data is selected based at least in part on the change in position.

6. The apparatus of claim 2, wherein, to cause the apparatus to sense, via the one or more radio frequency signals, the one or more processor-readable instructions are further executable by the one or more processors individually or collectively to cause the apparatus to:
transmit the one or more radio frequency signals; and
receive one or more reflected radio frequency signals corresponding to the one or more radio frequency signals that reflected off the one or more objects.

7. The apparatus of claim 2, wherein, to cause the apparatus to sense, via the one or more radio frequency signals, the one or more processor-readable instructions are further executable by the one or more processors individually or collectively to cause the apparatus to:
receive the one or more radio frequency signals from the wireless communication device, wherein the one or more radio frequency signals reflected off the one or more objects.

8. The apparatus of claim 2, wherein the one or more radio frequency signals comprise frequency range two radio frequency signals, sub-terahertz radio frequency signals, or a combination thereof.

9. The apparatus of claim 1, wherein the one or more processor-readable instructions are further executable by the one or more processors individually or collectively to cause the apparatus to:
communicate, with the wireless communication device, one or more radio frequency sensing parameters associated with the radio frequency sensing of the environment.

10. The apparatus of claim 9, wherein the one or more radio frequency sensing parameters comprise one or more of an angle of arrival, an angle of departure, a received signal strength indicator, a time difference of arrival, or a combination thereof.

11. The apparatus of claim 1, wherein the one or more processor-readable instructions are further executable by the one or more processors individually or collectively to cause the apparatus to:
communicate, with the wireless communication device, capability signaling indicating a capability of the wireless communication device to indicate subsets of intended portions of image data to remove based at least in part on radio frequency sensing of the environment, wherein transmitting the indication of the intended portion of the image data is based at least in part on the capability signaling.

12. The apparatus of claim 1, wherein, to cause the apparatus to remove the subset of image data, the one or more processor-readable instructions are further executable by the one or more processors individually or collectively to cause the apparatus to:
remove the subset of image data from the image or from a field-of-view region of the image, the field-of-view region being based at least in part on one or more sensors associated with the UE.

13. The apparatus of claim 12, wherein the subset of image data is removed in accordance with the inpainting scheme based at least in part on the radio frequency sensing of the environment.

14. The apparatus of claim 1, wherein, to cause the apparatus to remove the subset of image data, the one or more processor-readable instructions are further executable by the one or more processors individually or collectively to cause the apparatus to:
remove a masked portion of the image, remove a set of masked portions from each image in a corresponding set of images, remove a frame image from a video, or a combination thereof.

15. The apparatus of claim 1, wherein the one or more processor-readable instructions are further executable by the one or more processors individually or collectively to cause the apparatus to:
communicate with the wireless communication device to train the inpainting scheme to recover the image from the compressed image, wherein the inpainting scheme is based at least in part on the training.

16. The apparatus of claim 1, wherein, to cause the apparatus to transmit the indication of the intended portion of the image data, the one or more processor-readable instructions are further executable by the one or more processors individually or collectively to cause the apparatus to:
transmit the indication via a radio frequency band, wherein the radio frequency sensing is associated with the radio frequency band.

17. The apparatus of claim 1, wherein the masked image comprises a remainder of the intended portion of image data other than the subset of image data.

18. An apparatus for wireless communication at a wireless communication device, comprising:
one or more processors;
one or more memories coupled with the one or more processors; and
one or more processor-readable instructions stored in the one or more memories and executable by the one or more processors individually or collectively to cause the apparatus to:
receive, from a user equipment (UE), an indication of an intended portion of image data to remove from an image in accordance with an inpainting scheme;
sense, via one or more radio frequency signals, one or more objects in an environment associated with the image;
transmit, to the UE, an indication of at least a subset of image data of the intended portion of the image data to remove from the image in accordance with the inpainting scheme and based at least in part on the one or more objects in the environment sensed via the one or more radio frequency signals;
receive, from the UE, a compressed image;
decompress, according to a compression scheme, the compressed image to obtain a masked image; and
reconstruct, according to the inpainting scheme and the indication of the subset of image data of the intended portion of the image data to remove, the image from the masked image.

19. The apparatus of claim 18, wherein the one or more processor-readable instructions are further executable by the one or more processors individually or collectively to cause the apparatus to:
determine, based at least in part on the sensing, that one or more second objects block the one or more objects with respect to a field of view of the UE, wherein the subset of image data is based at least in part on determining that the one or more second objects block the one or more objects with respect to the field of view of the UE.

20. The apparatus of claim 19, wherein the one or more processor-readable instructions are further executable by the one or more processors individually or collectively to cause the apparatus to:
receive, from the UE, one or more second images prior to receiving the indication of the intended portion of the image data to remove, wherein the inpainting scheme is based at least in part on the one or more second images, and wherein the one or more second objects are absent from the one or more second images.

21. The apparatus of claim 20, wherein the one or more processor-readable instructions are further executable by the one or more processors individually or collectively to cause the apparatus to:
determine, based at least in part on the sensing, a change in position of the one or more objects at a time subsequent to the one or more second images, wherein the subset of image data is based at least in part on the change in position.

22. The apparatus of claim 18, wherein, to cause the apparatus to sense, via the one or more radio frequency signals, the one or more processor-readable instructions are further executable by the one or more processors individually or collectively to cause the apparatus to:
transmit the one or more radio frequency signals; and
receive one or more reflected radio frequency signals corresponding to the one or more radio frequency signals that reflected off the one or more objects.

23. The apparatus of claim 18, wherein, to cause the apparatus to sense, via the one or more radio frequency signals, the one or more processor-readable instructions are further executable by the one or more processors individually or collectively to cause the apparatus to:
receive the one or more radio frequency signals from the UE, wherein the one or more radio frequency signals reflected off the one or more objects.

24. The apparatus of claim 18, wherein the one or more radio frequency signals comprise frequency range two radio frequency signals, sub-terahertz radio frequency signals, or a combination thereof.

25. The apparatus of claim 18, wherein the one or more processor-readable instructions are further executable by the one or more processors individually or collectively to cause the apparatus to:
communicate, with the UE, one or more radio frequency sensing parameters associated with radio frequency sensing of the environment, wherein the sensing is based at least in part on the one or more radio frequency sensing parameters.

26. The apparatus of claim 25, wherein the one or more radio frequency sensing parameters comprise one or more of an angle of arrival, an angle of departure, a received signal strength indicator, a time difference of arrival, or a combination thereof.

27. The apparatus of claim 18, wherein the one or more processor-readable instructions are further executable by the one or more processors individually or collectively to cause the apparatus to:
communicate, with the UE, capability signaling indicating a capability of the wireless communication device to indicate subsets of intended portions of image data to remove based at least in part on radio frequency sensing of the environment, wherein reception of the indication of the intended portion of the image data is based at least in part on the capability signaling.

28. The apparatus of claim 18, wherein the one or more processor-readable instructions are further executable by the one or more processors individually or collectively to cause the apparatus to:
communicate with the UE to train the inpainting scheme to recover the image from the compressed image, wherein the inpainting scheme is based at least in part on the training.

29. The apparatus of claim 18, wherein the one or more processor-readable instructions are further executable by the one or more processors individually or collectively to cause the apparatus to:
receive the indication via a radio frequency band, wherein the one or more radio frequency signals are associated with the radio frequency band.

30. The apparatus of claim 18, wherein the image is reconstructed from the masked image according to the inpainting scheme based at least in part on the sensing.

31. A method for wireless communications at a user equipment (UE), comprising:
transmitting, to a wireless communication device, an indication of an intended portion of image data to remove from an image in accordance with an inpainting scheme;
receiving, from the wireless communication device, an indication of at least a subset of image data of the intended portion of the image data to remove from the image in accordance with the inpainting scheme and a radio frequency sensing of an environment associated with the image;
removing the subset of image data to obtain a masked image, the masked image having less data than the image;
compressing, according to a compression scheme, the masked image to obtain a compressed image, the compressed image having less data than the masked image based at least in part on the compression; and
transmitting, to the wireless communication device, the compressed image.

32. The method of claim 31, further comprising:
sensing, via one or more radio frequency signals, one or more objects in the environment, wherein the intended portion of the image data is selected based at least in part on the sensing the one or more objects.

33. The method of claim 32, further comprising:
capturing, via an image sensor of the UE, the image, wherein one or more second objects block the one or more objects with respect to the image sensor.

34. The method of claim 33, further comprising:
capturing, via the image sensor, one or more second images prior to capture of the image, wherein the inpainting scheme is based at least in part on the one or more second images, and wherein the one or more second objects are absent from the one or more second images.

35. The method of claim 34, further comprising:
determining, based at least in part on the sensing, a change in position of the one or more objects at a time of the image with respect to the one or more second images, wherein the intended portion of the image data is selected based at least in part on the change in position.

36. The method of claim 32, wherein sensing, via the one or more radio frequency signals comprises:
transmitting the one or more radio frequency signals; and
receiving one or more reflected radio frequency signals corresponding to the one or more radio frequency signals that reflected off the one or more objects.

37. A method for wireless communications at a wireless communication device, comprising:
receiving, from a user equipment (UE), an indication of an intended portion of image data to remove from an image in accordance with an inpainting scheme;
sensing, via one or more radio frequency signals, one or more objects in an environment associated with the image;
transmitting, to the UE, an indication of at least a subset of image data of the intended portion of the image data to remove from the image in accordance with the inpainting scheme and based at least in part on the one or more objects in the environment sensed via the one or more radio frequency signals;
receiving, from the UE, a compressed image;
decompressing, according to a compression scheme, the compressed image to obtain a masked image; and
reconstructing, according to the inpainting scheme and the indication of the subset of image data of the intended portion of the image data to remove, the image from the masked image.

38. The method of claim 37, further comprising:
determining, based at least in part on the sensing, that one or more second objects block the one or more objects with respect to a field of view of the UE, wherein the subset of image data is based at least in part on determining that the one or more second objects block the one or more objects with respect to the field of view of the UE.

39. The method of claim 38, further comprising:
receiving, from the UE, one or more second images prior to receiving the indication of the intended portion of the image data to remove, wherein the inpainting scheme is based at least in part on the one or more second images, and wherein the one or more second objects are absent from the one or more second images.

40. The method of claim 39, further comprising:
determining, based at least in part on the sensing, a change in position of the one or more objects at a time subsequent to the one or more second images, wherein the subset of image data is based at least in part on the change in position.
